(19) United States
(12) Patent Application Publication
(10) Pub. No.: US 2015/0031290 A1
(43) Pub. Date: Jan. 29, 2015

(54) SYSTEMS AND METHODS FOR PROVIDING ONE OR MORE FUNCTIONALITIES TO A WEARABLE COMPUTING DEVICE WITH SMALL FORM FACTOR

(71) Applicant: Elwha LLC, Bellevue, WA (US)

(72) Inventors: Pablos Holman, Seattle, WA (US); Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US); Clarence T. Tegreene, Mercer Island, WA (US)

(21) Appl. No.: 13/950,926

(22) Filed: Jul. 25, 2013

(51) Int. Cl. H04B 7/26; H04W 4/00

(52) U.S. Cl. CPC H04B 7/26; H04W 4/008
USPC 455/41.2

(57) ABSTRACT

A method substantially as shown and described in the detailed description and/or drawings and/or elsewhere herein. A device substantially as shown and described in the detailed description and/or drawings and/or elsewhere herein.

### CROSS-REFERENCE TO RELATED APPLICATIONS

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

None as of the filing date.

### RELATED APPLICATIONS

None as of the filing date.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### SUMMARY

In one or more various aspects, a method includes but is not limited to that which is illustrated in the drawings. In addition to the foregoing, other method aspects are described in the claims, drawings, and text forming a part of the disclosure set forth herein.

In one or more various aspects, one or more related systems may be implemented in machines, compositions of matter, or manufactures of systems, limited to patentable subject matter under 35 U.S.C. 101. The one or more related systems may include, but are not limited to, circuitry and/or programming for effecting the herein-referenced method aspects. The circuitry and/or programming may be virtually any combination of hardware, software, and/or firmware configured to effect the herein-referenced method aspects depending upon the design choices of the system designer, and limited to patentable subject matter under 35 USC 101.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent by reference to the detailed description, the corresponding drawings, and/or in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1, including FIG. 1-A through FIG. 1-AP shows a partially schematic diagram of an environment(s) and/or an implementation(s) of technologies described herein. The figures are ordered alphabetically, first by increasing column from left to right, then by increasing row from top to bottom, as shown in the following table:

TABLE 1
Alignment of drawings.

| | | | | | |
|---|---|---|---|---|---|
| FIG. 1-A | FIG. 1-B | FIG. 1-C | FIG. 1-D | FIG. 1-E | FIG. 1-F |
| FIG. 1-G | FIG. 1-H | FIG. 1-I | FIG. 1-J | FIG. 1-K | FIG. 1-L |
| FIG. 1-M | FIG. 1-N | FIG. 1-O | FIG. 1-P | FIG. 1-Q | FIG. 1-R |
| FIG. 1-S | FIG. 1-T | FIG. 1-U | FIG. 1-V | FIG. 1-W | FIG. 1-X |
| FIG. 1-Y | FIG. 1-Z | FIG. 1-AA | FIG. 1-AB | FIG. 1-AC | FIG. 1-AD |
| FIG. 1-AE | FIG. 1-AF | FIG. 1-AG | FIG. 1-AH | FIG. 1-AI | FIG. 1-AJ |
| FIG. 1-AK | FIG. 1-AL | FIG. 1-AM | FIG. 1-AN | FIG. 1-AO | FIG. 1-AP |

FIGS. 2A, 2B, 2C, and 2D show exemplary Graphical User Interfaces (GUIs) that may be displayed by a wearable computing device.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

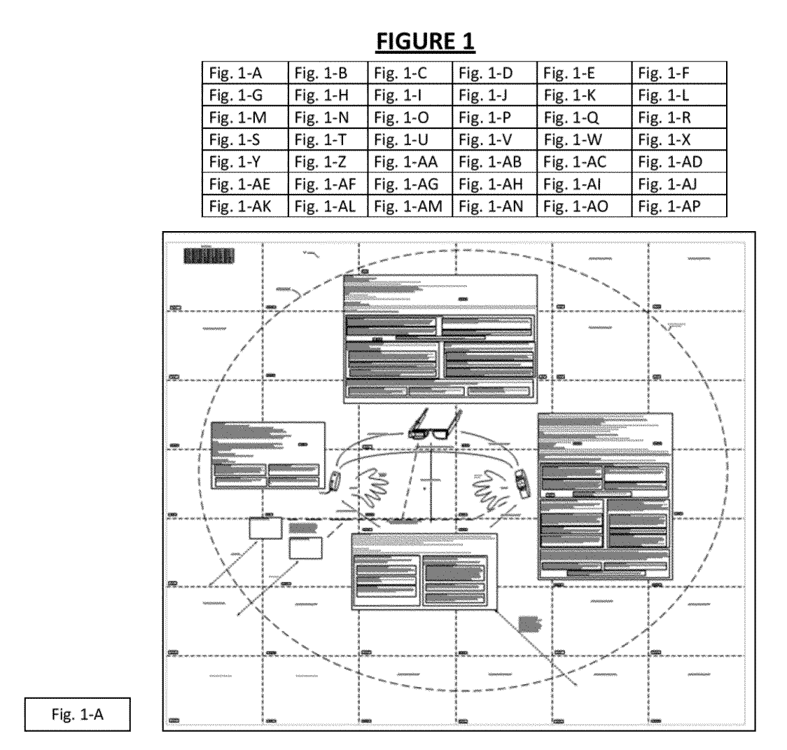

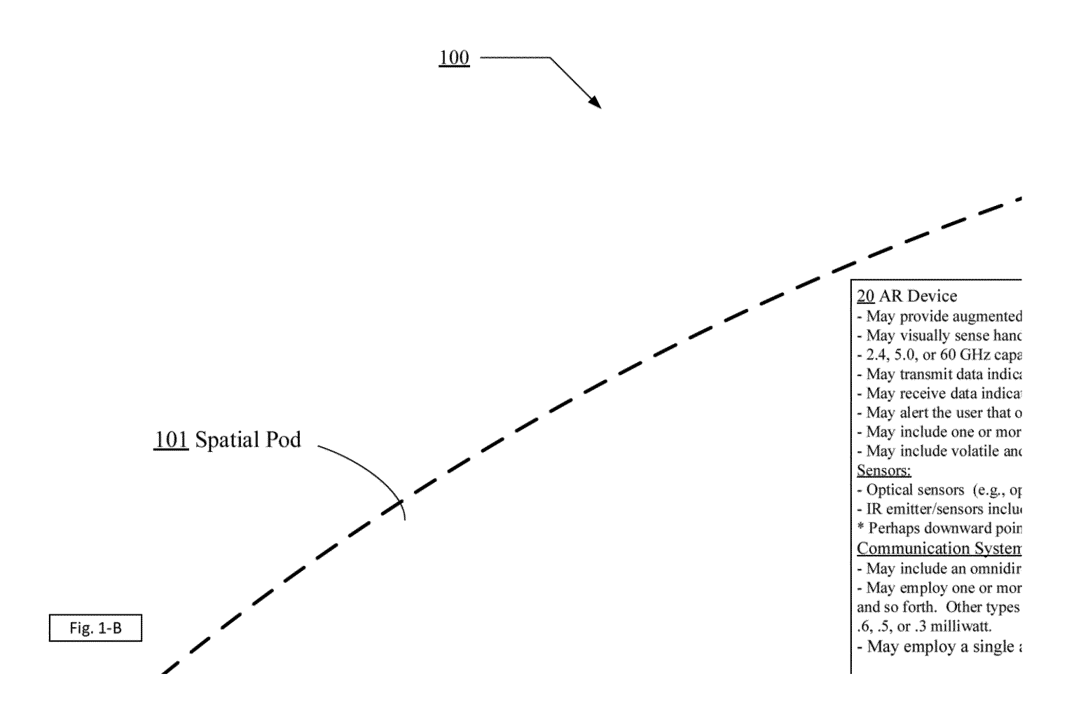

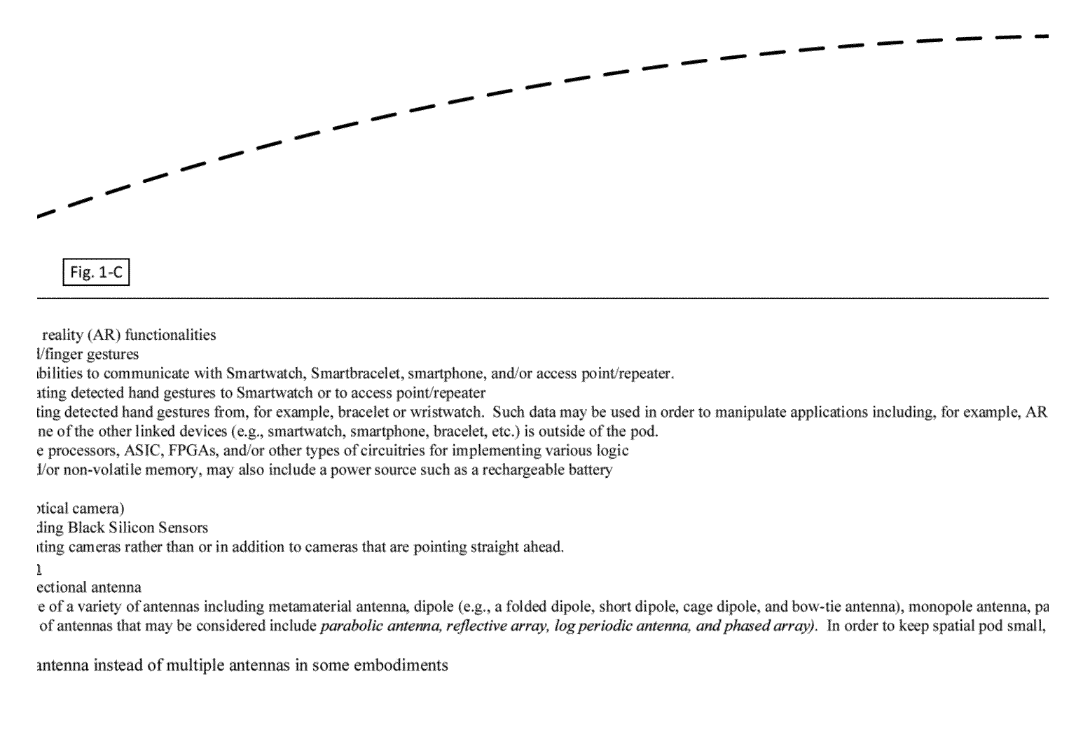

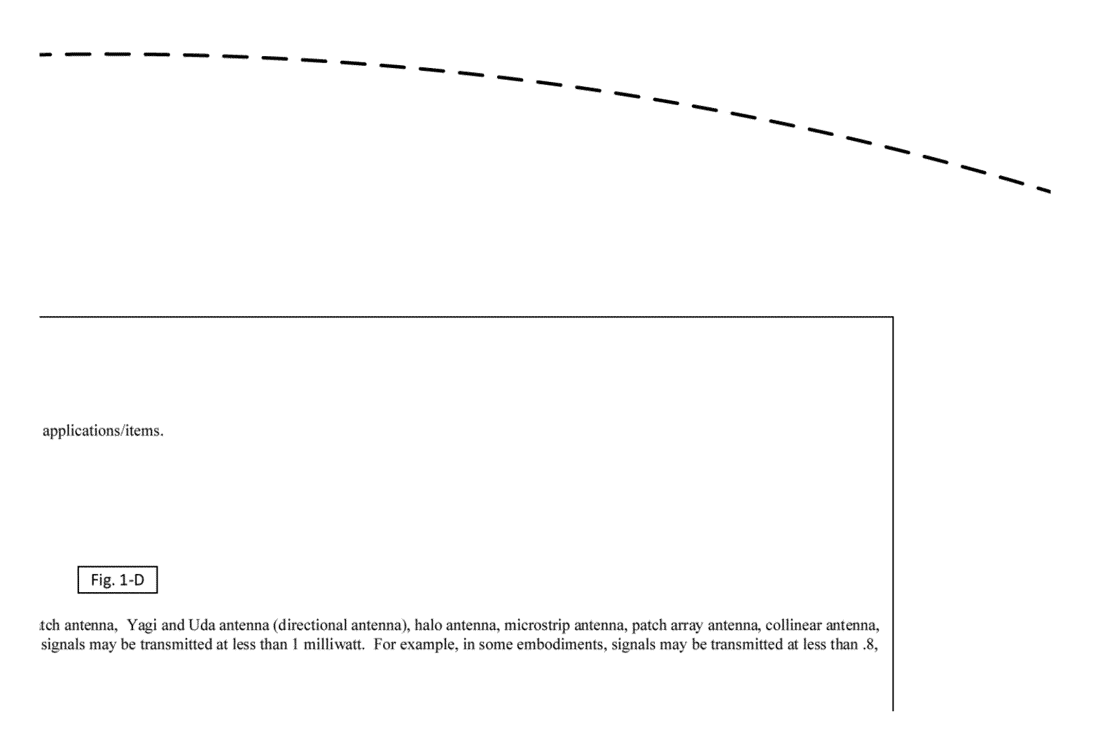

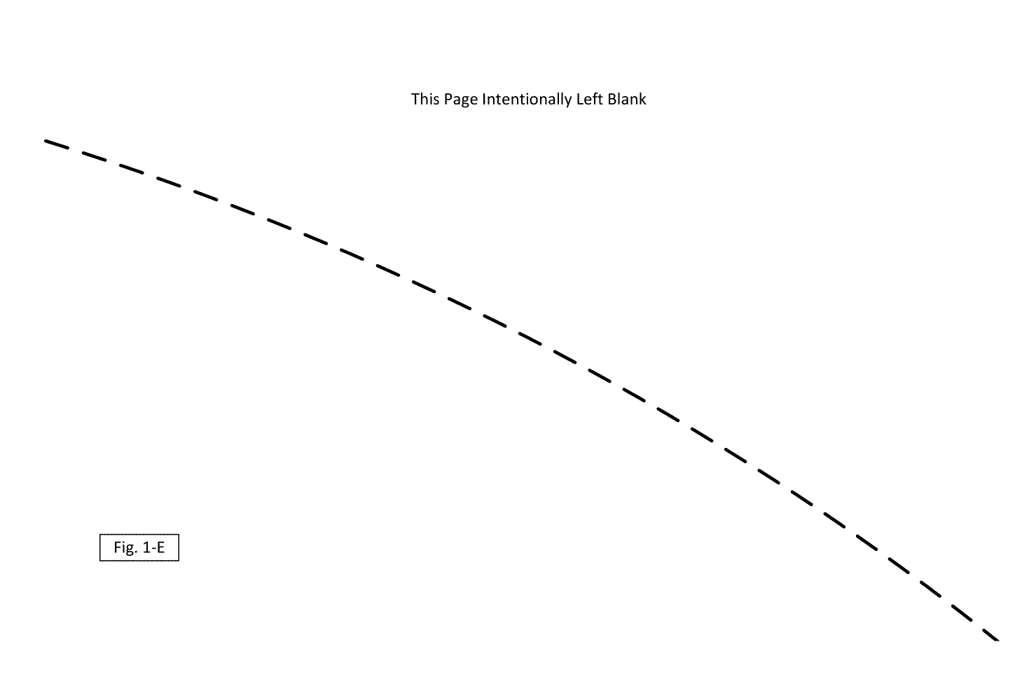

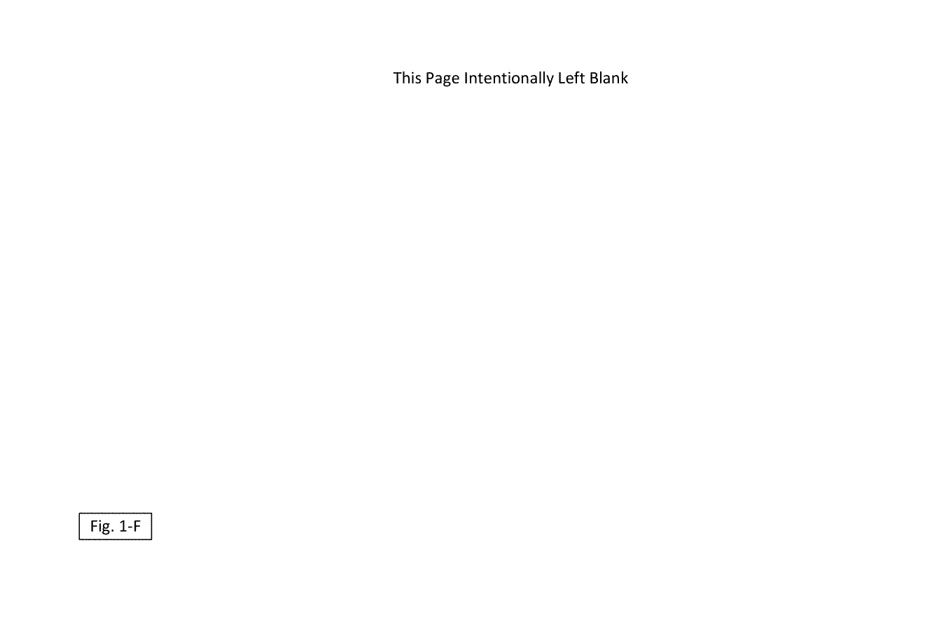

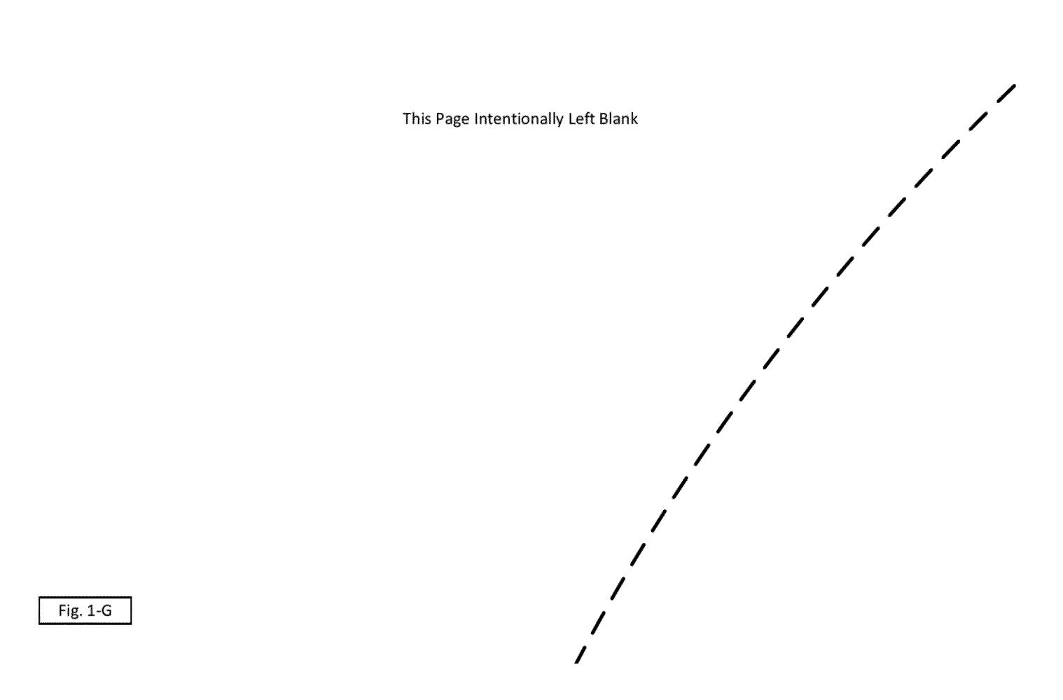

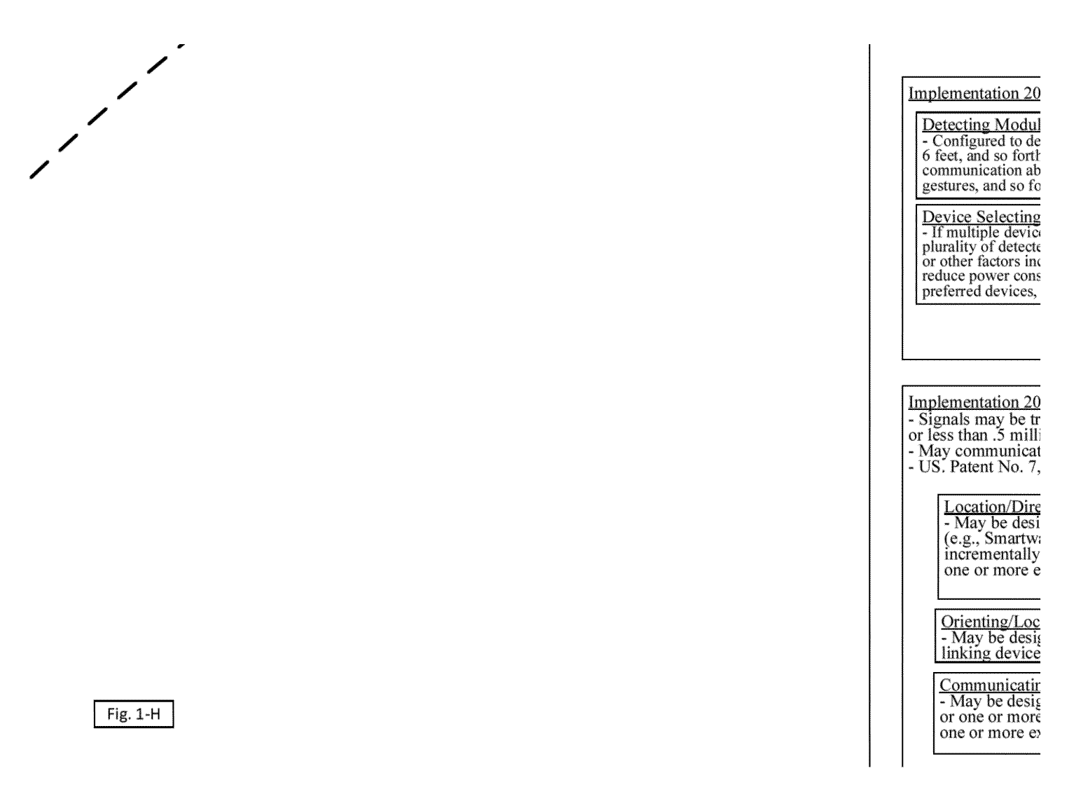

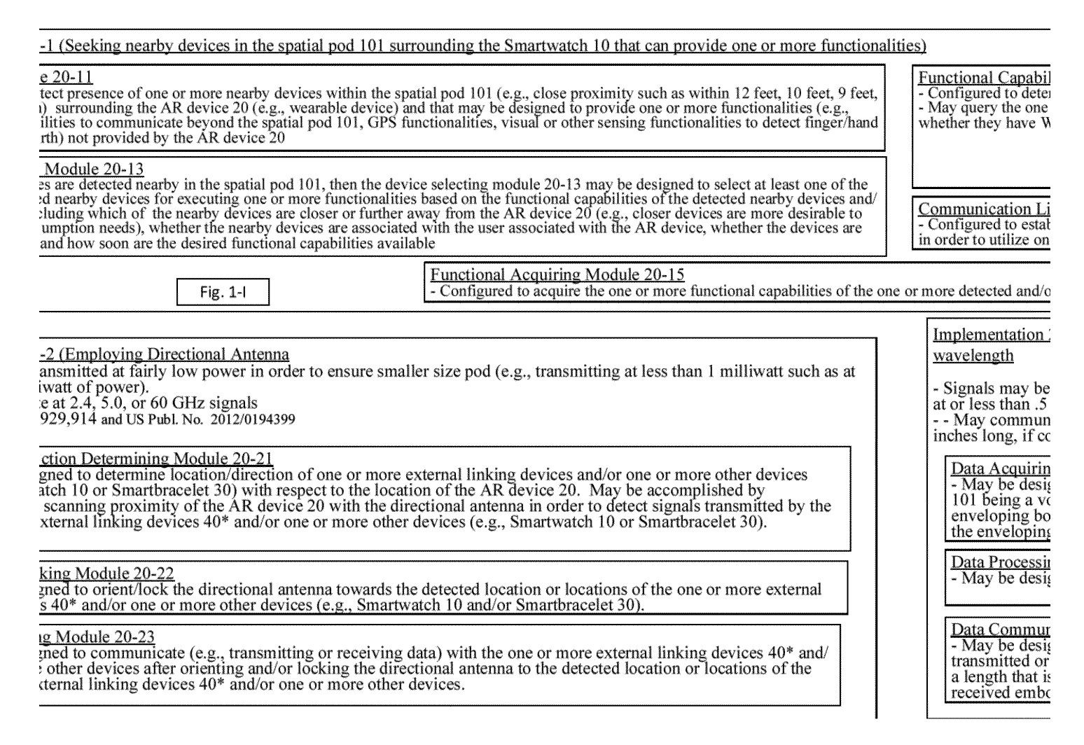

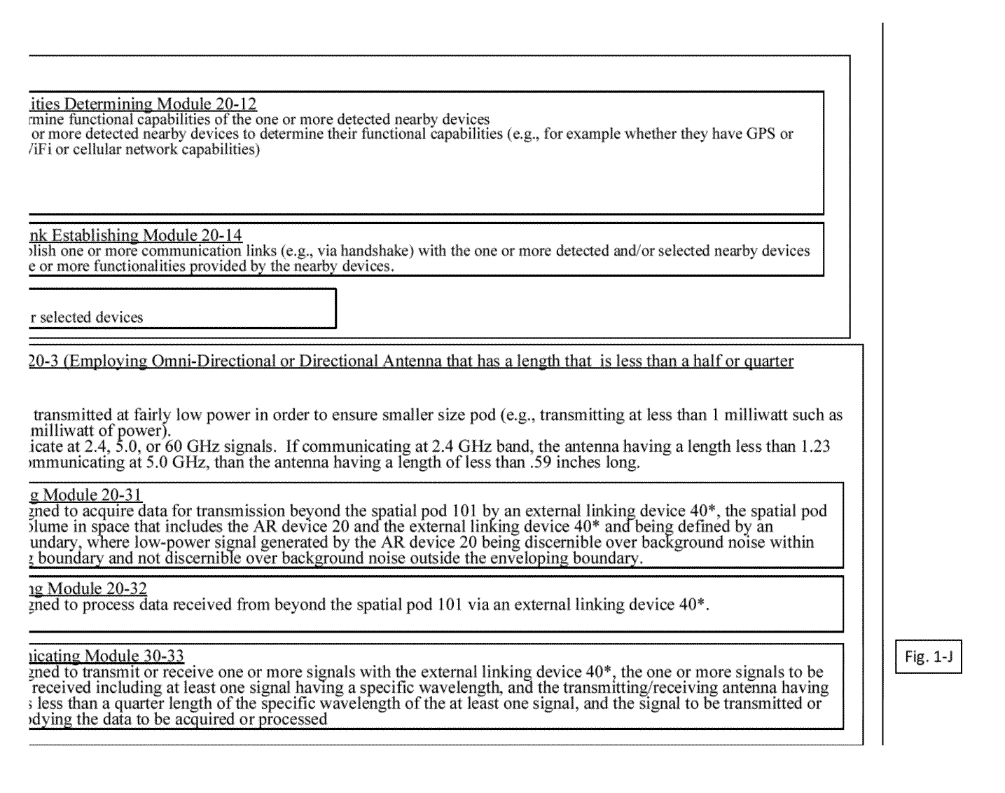

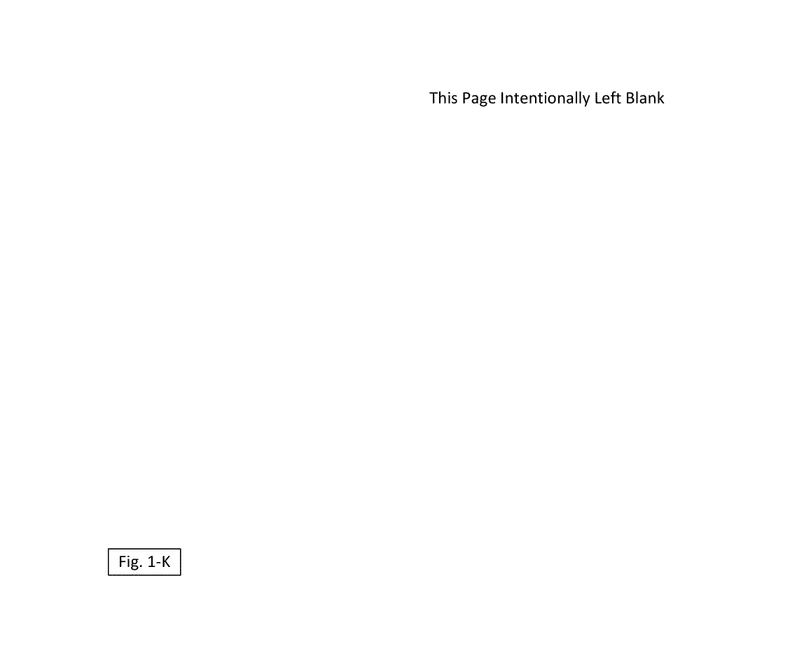

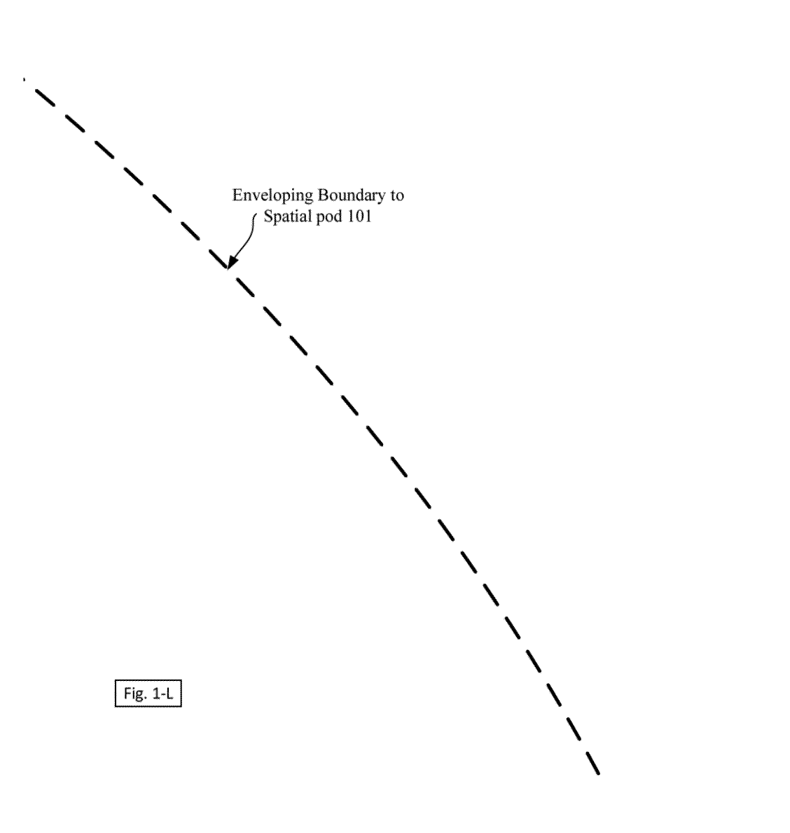

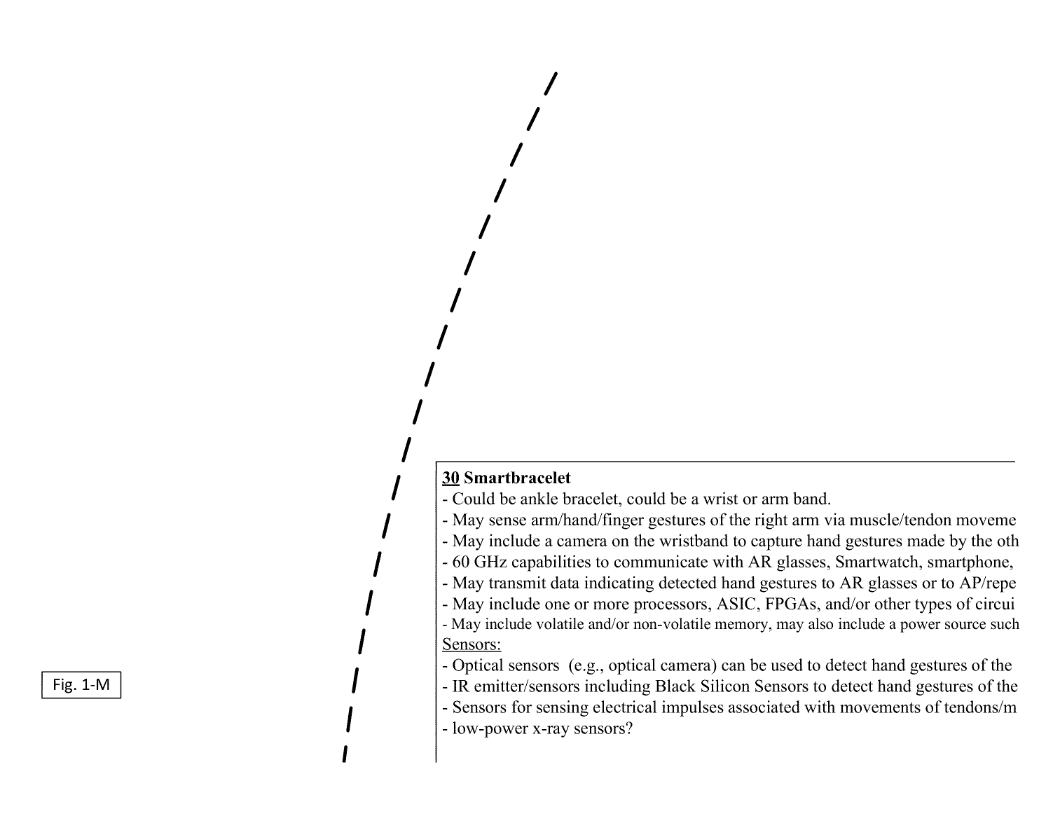

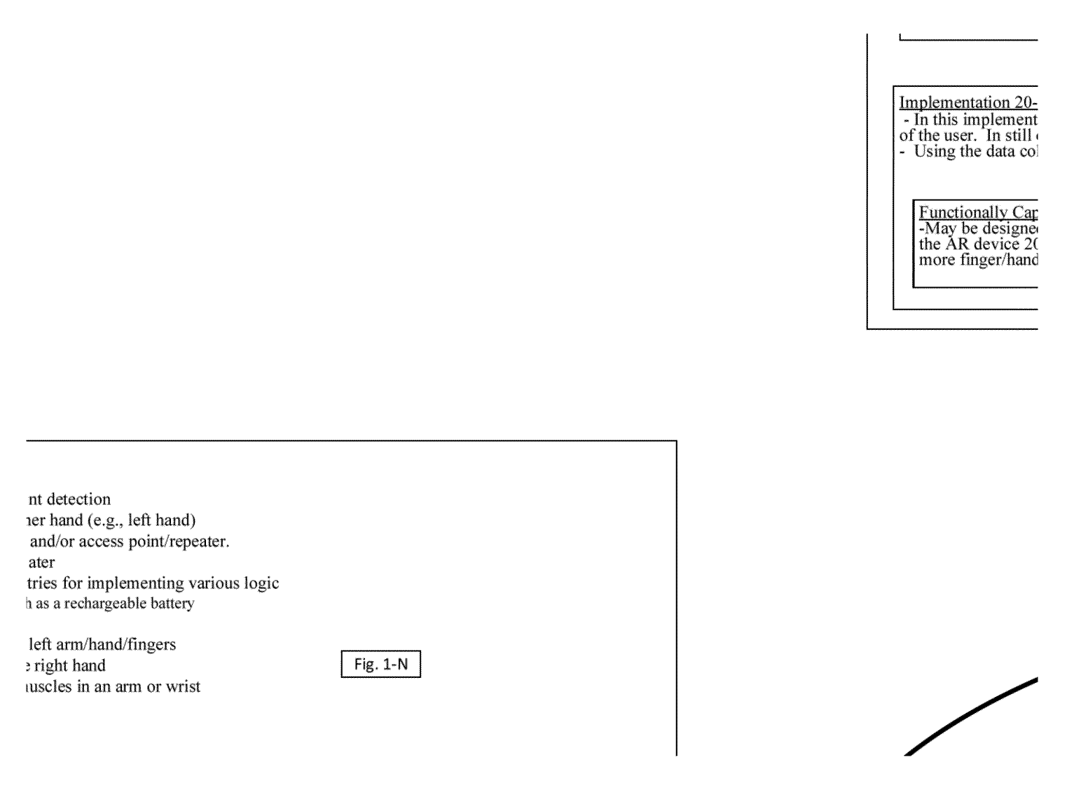

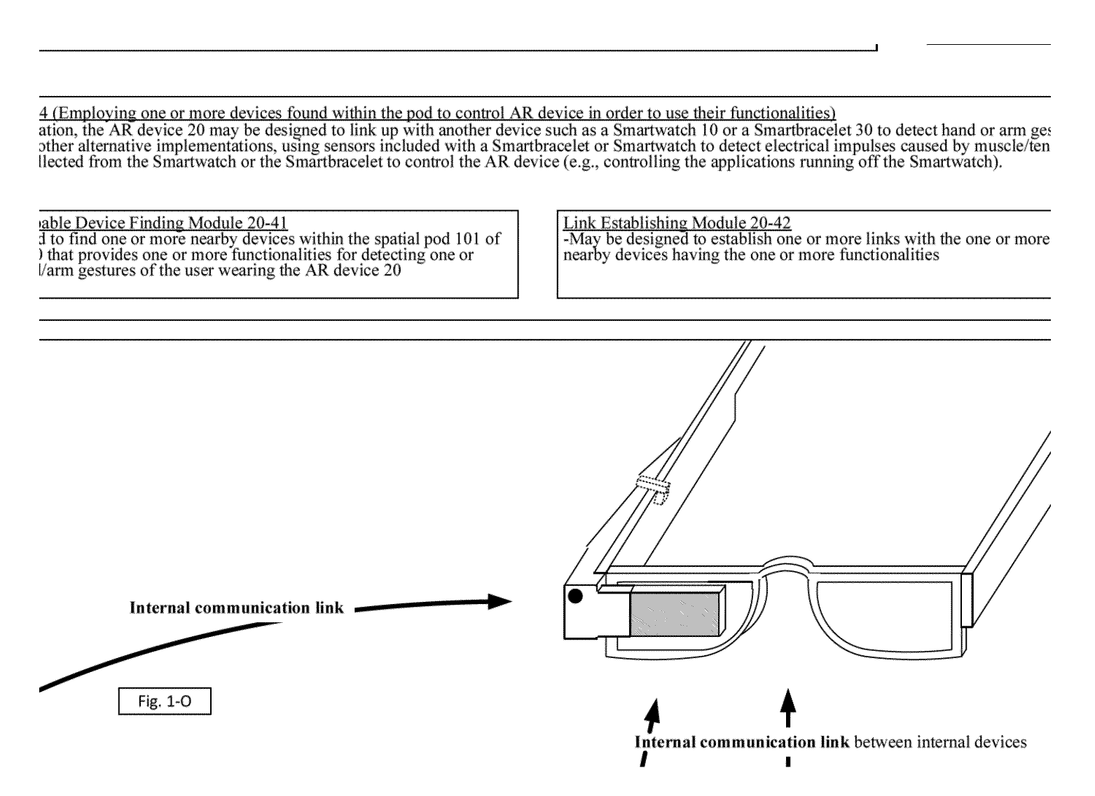

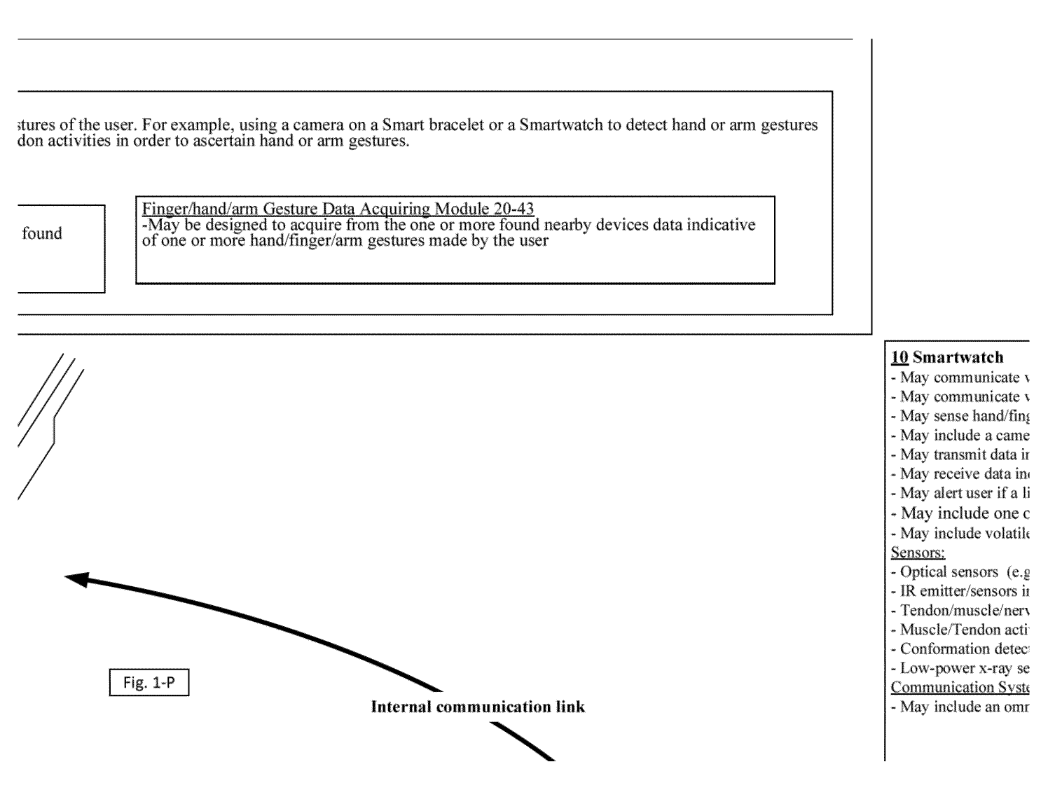

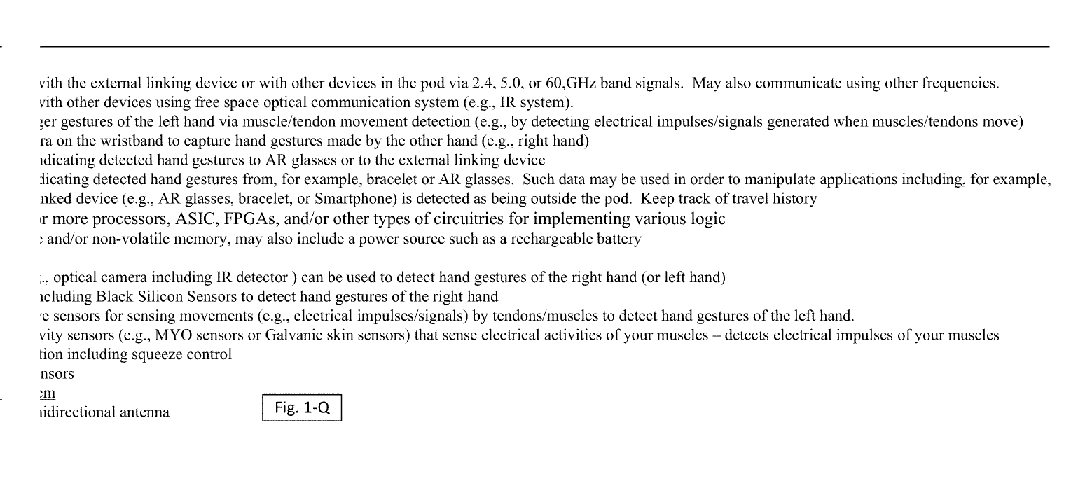

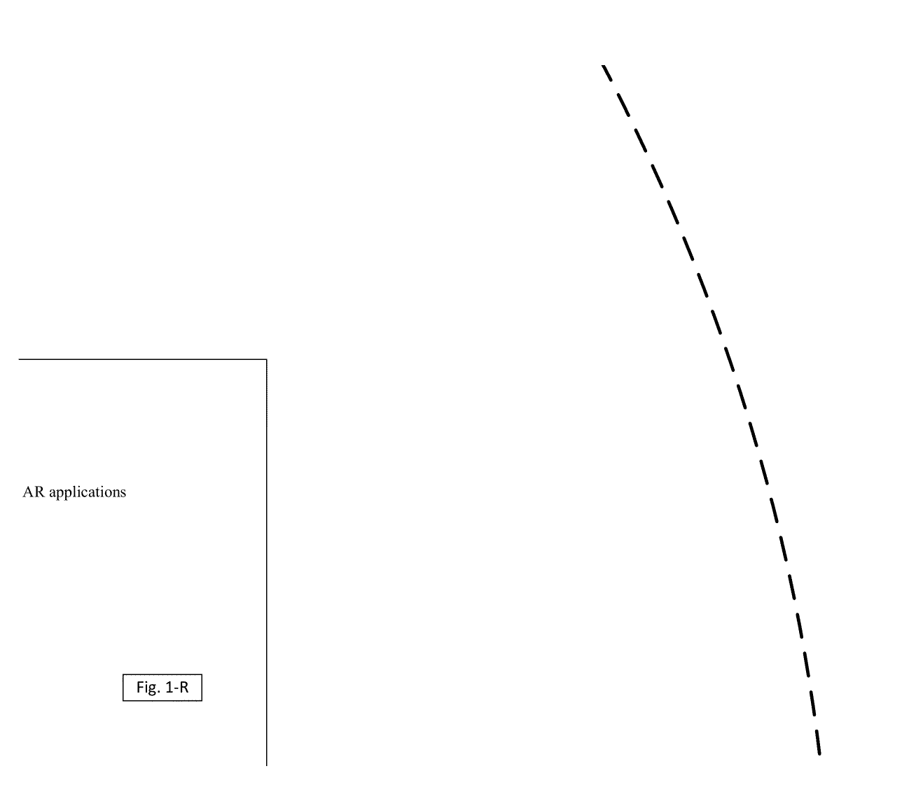

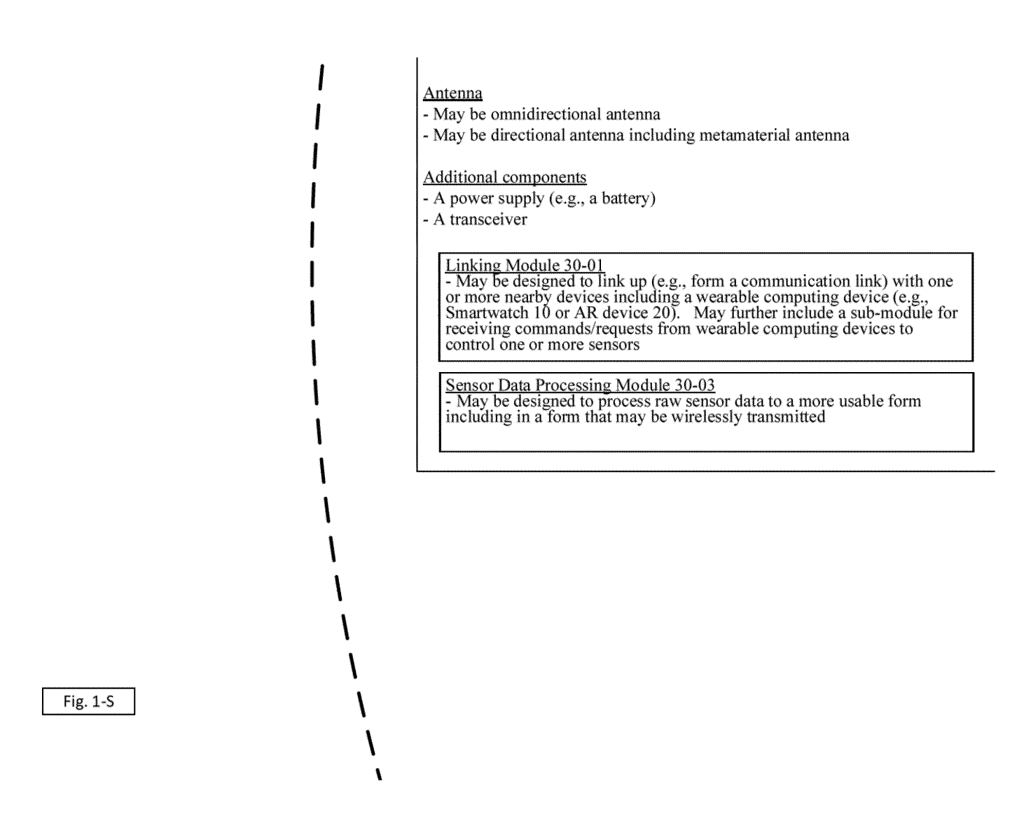

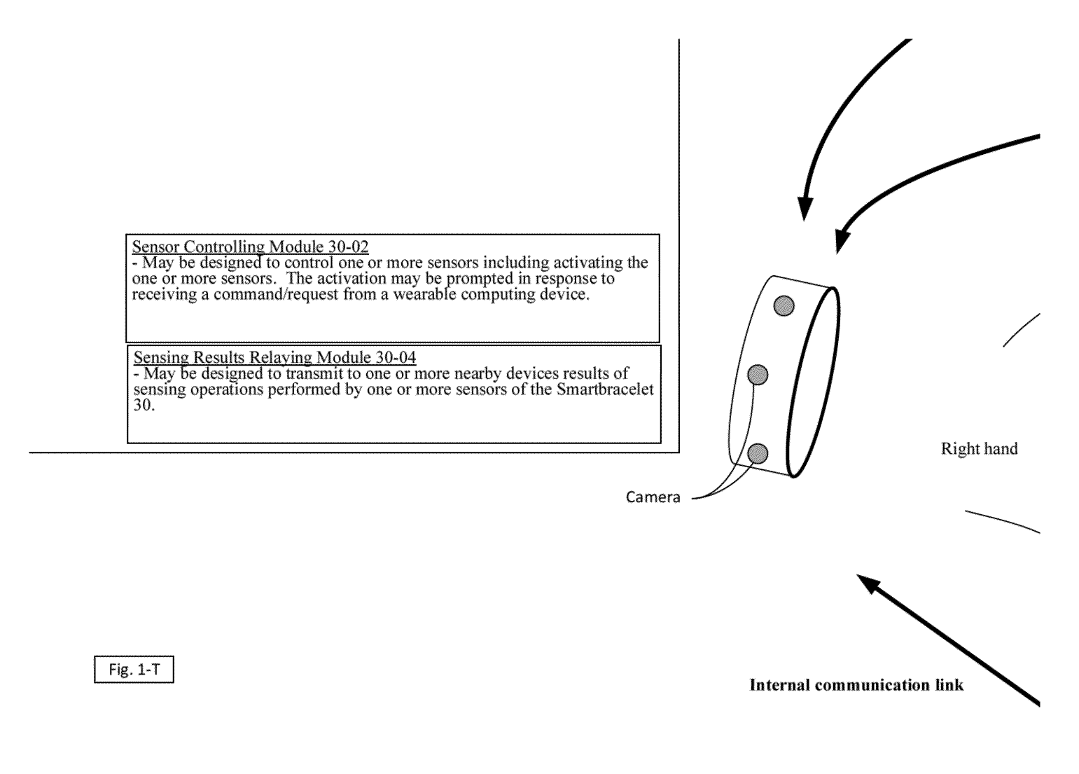

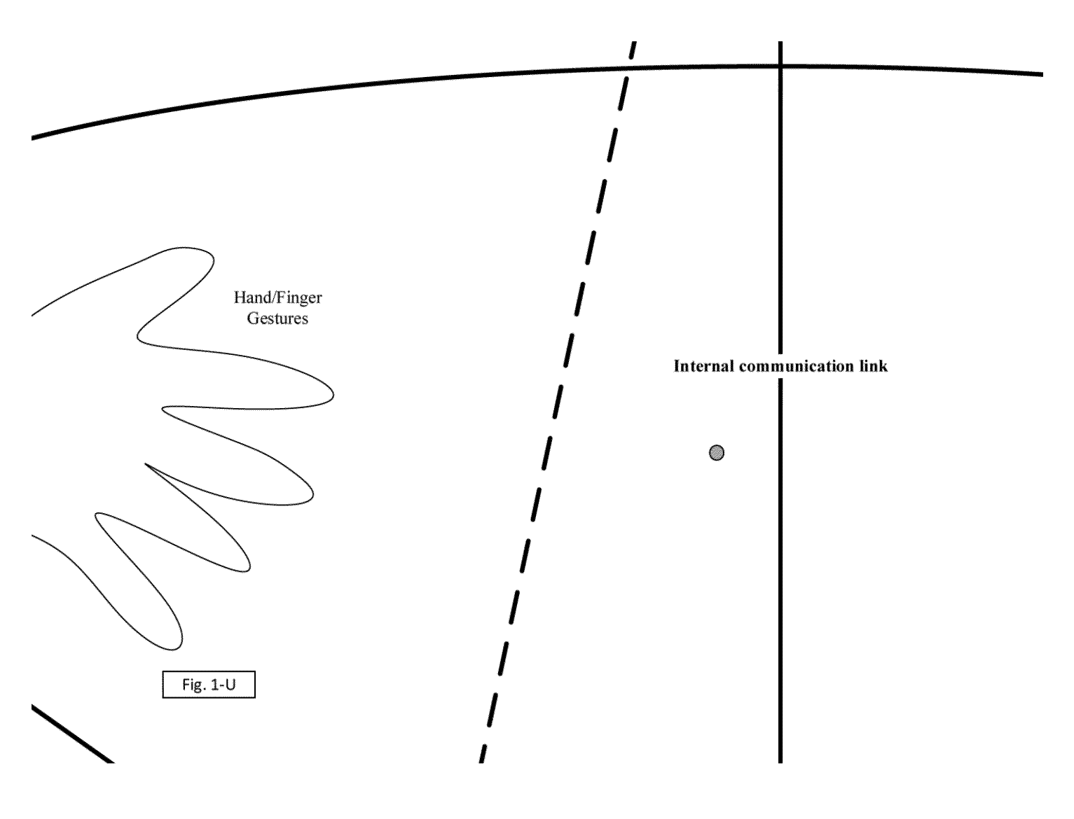

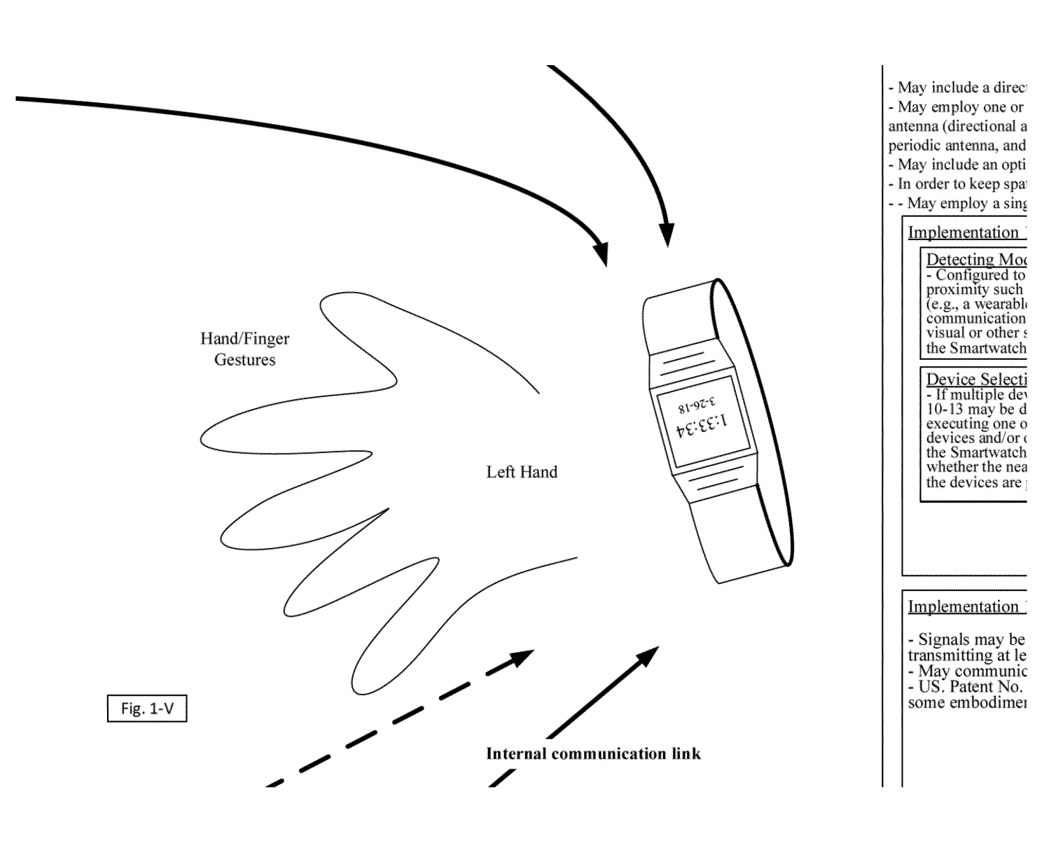

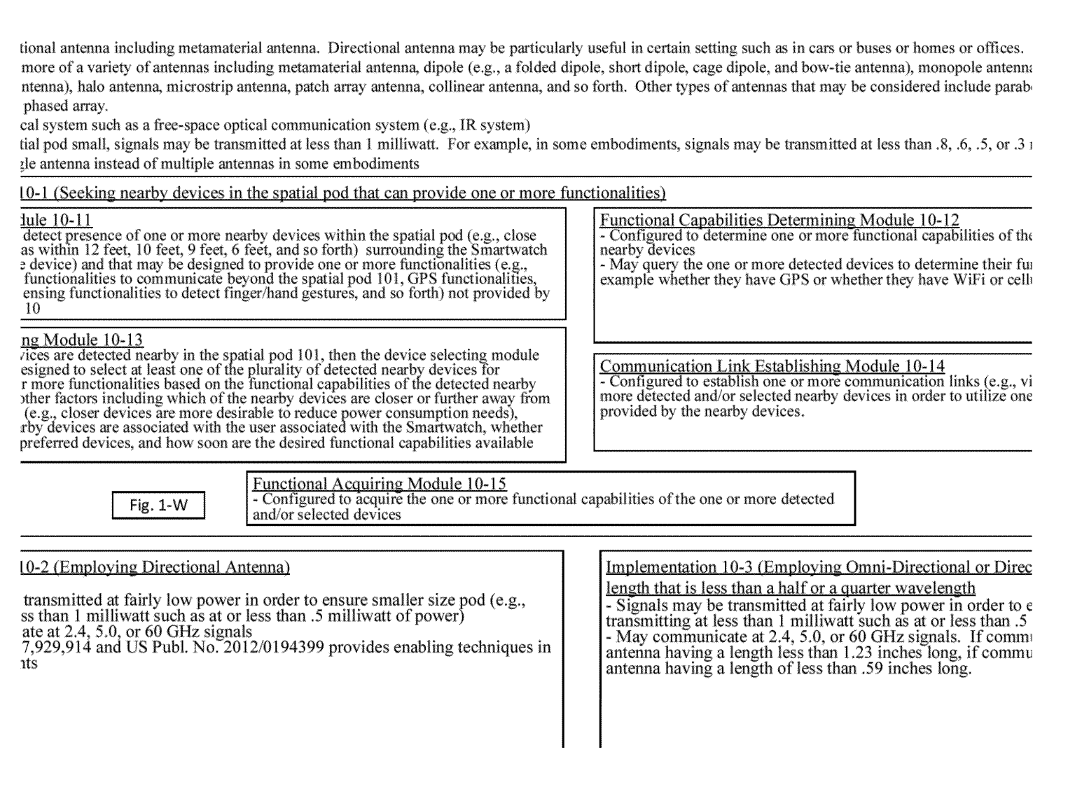

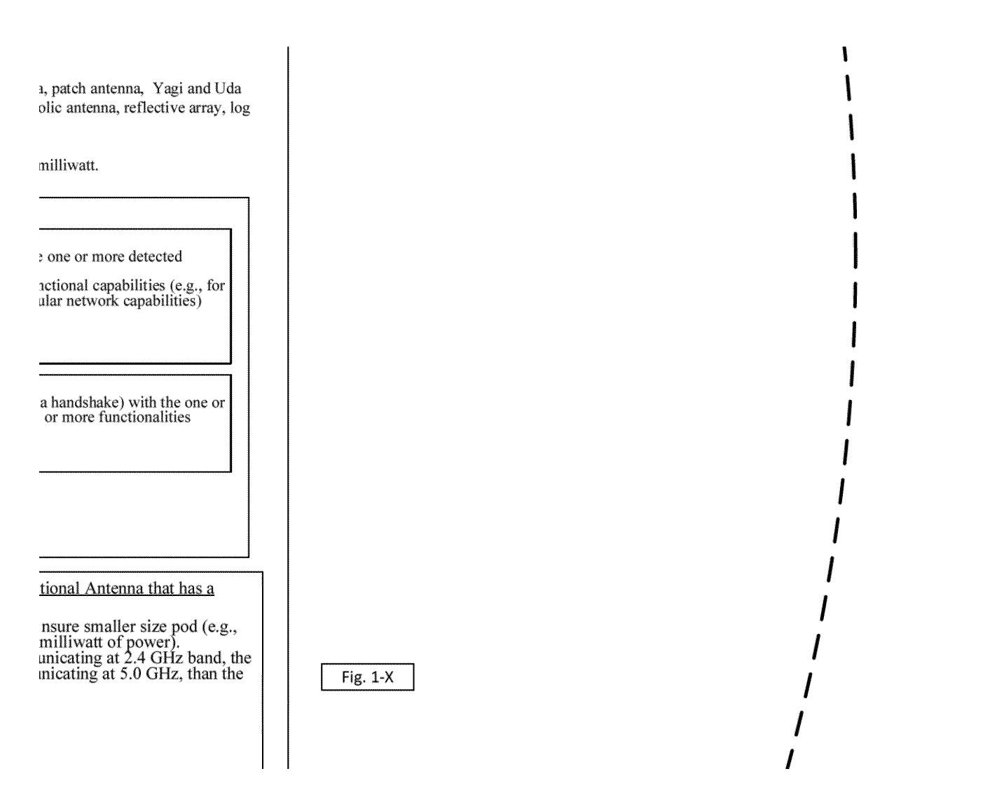

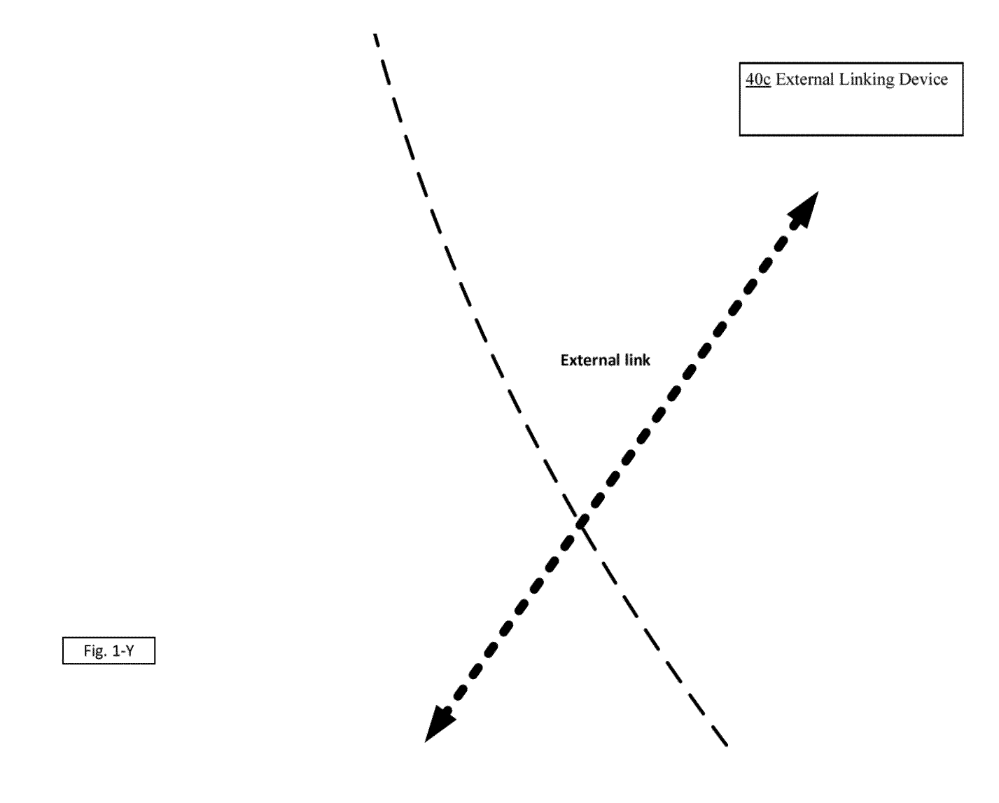

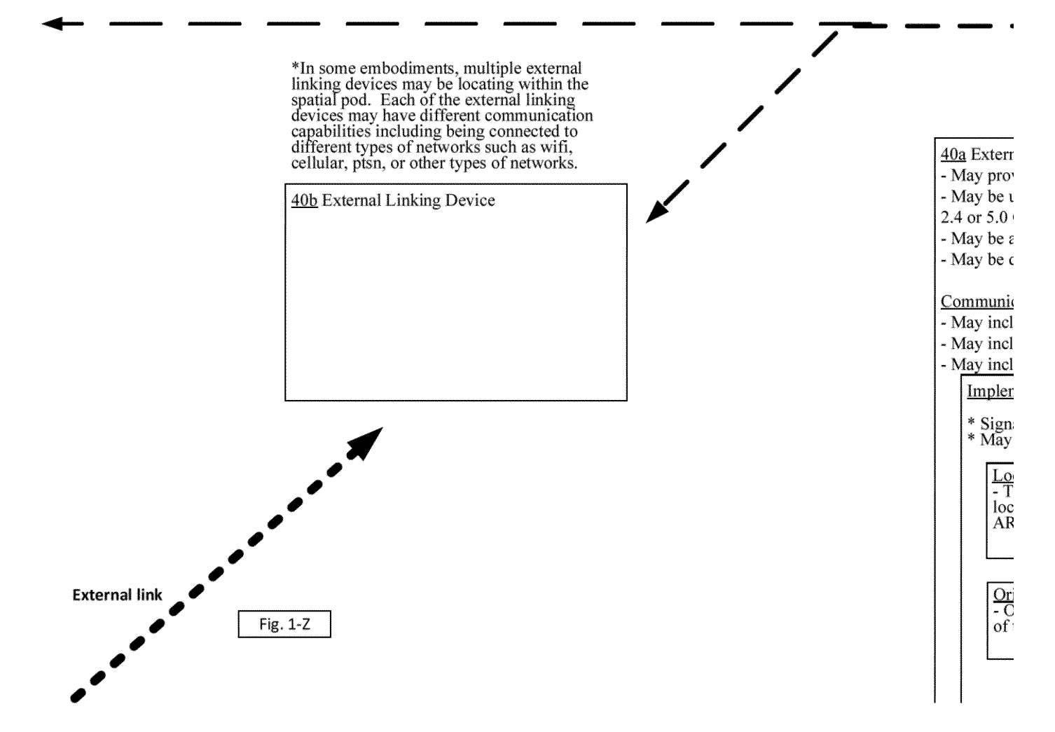

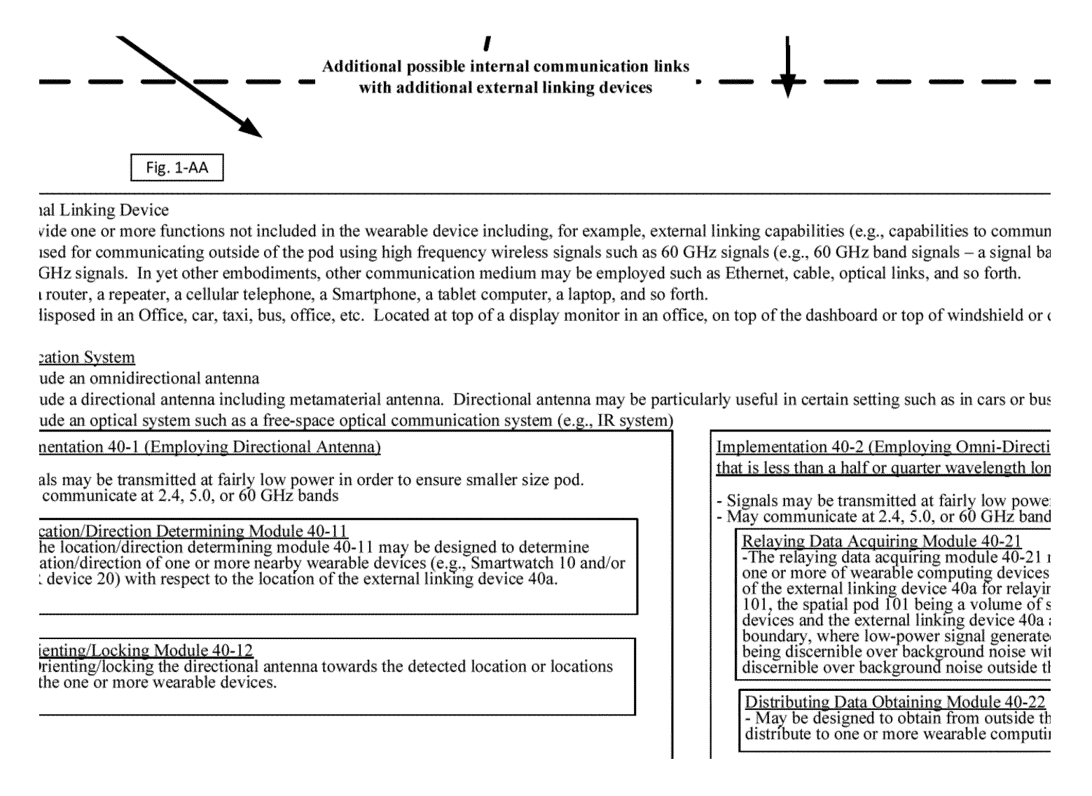

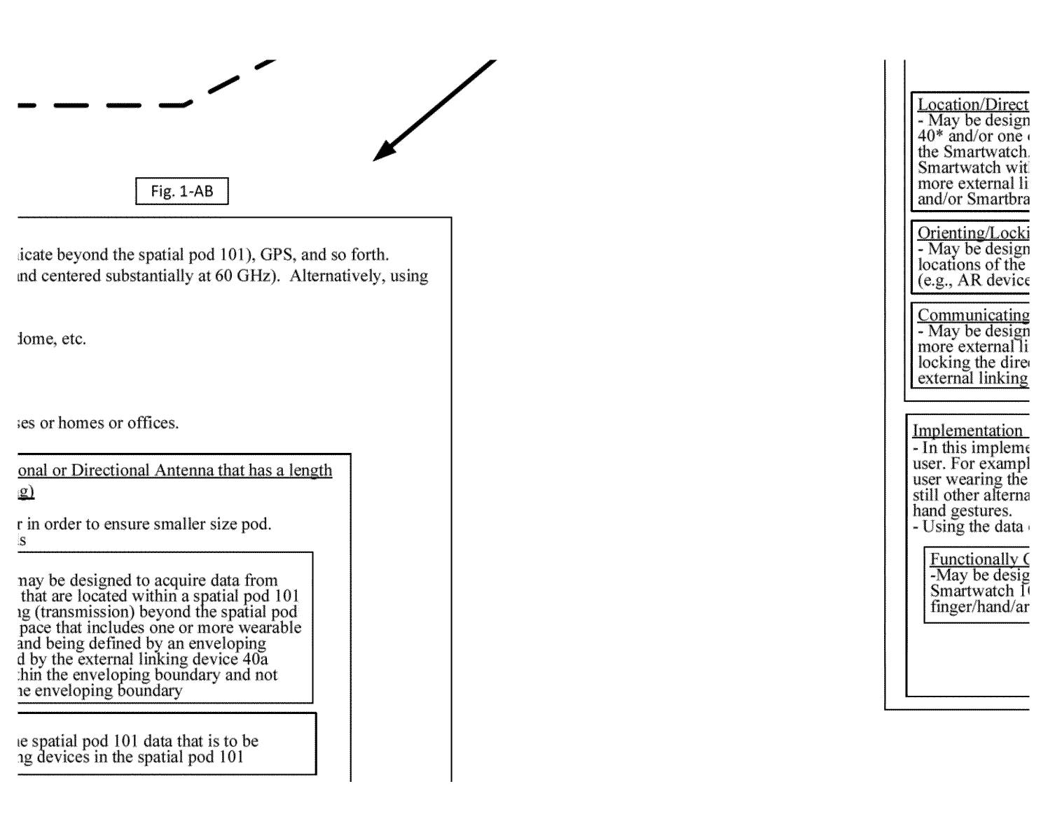

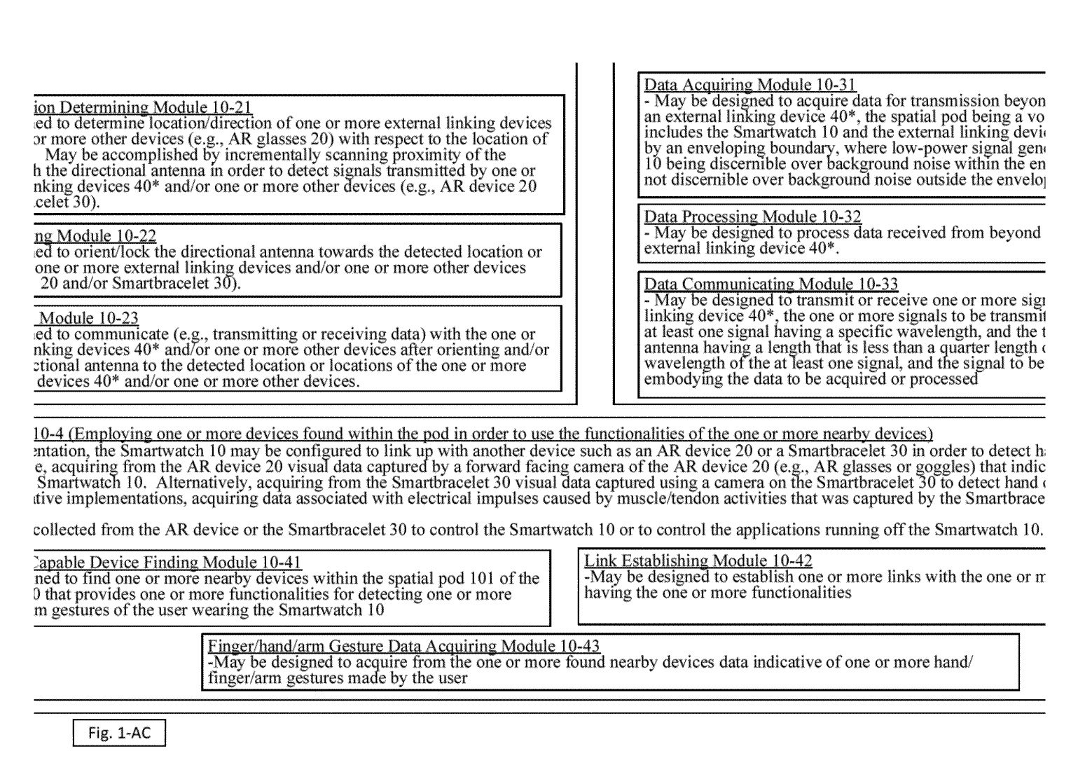

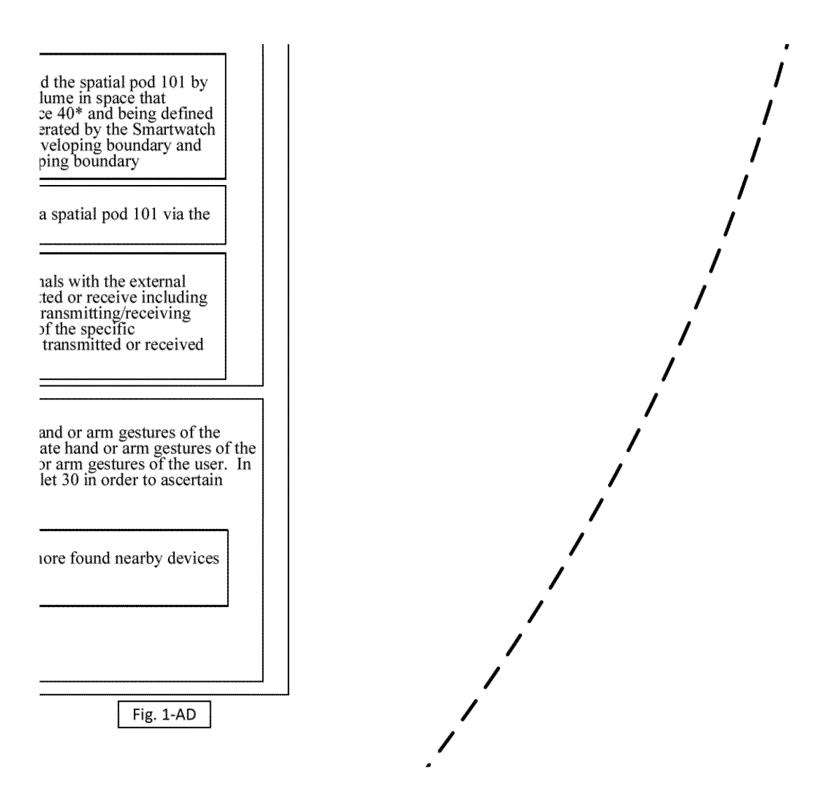

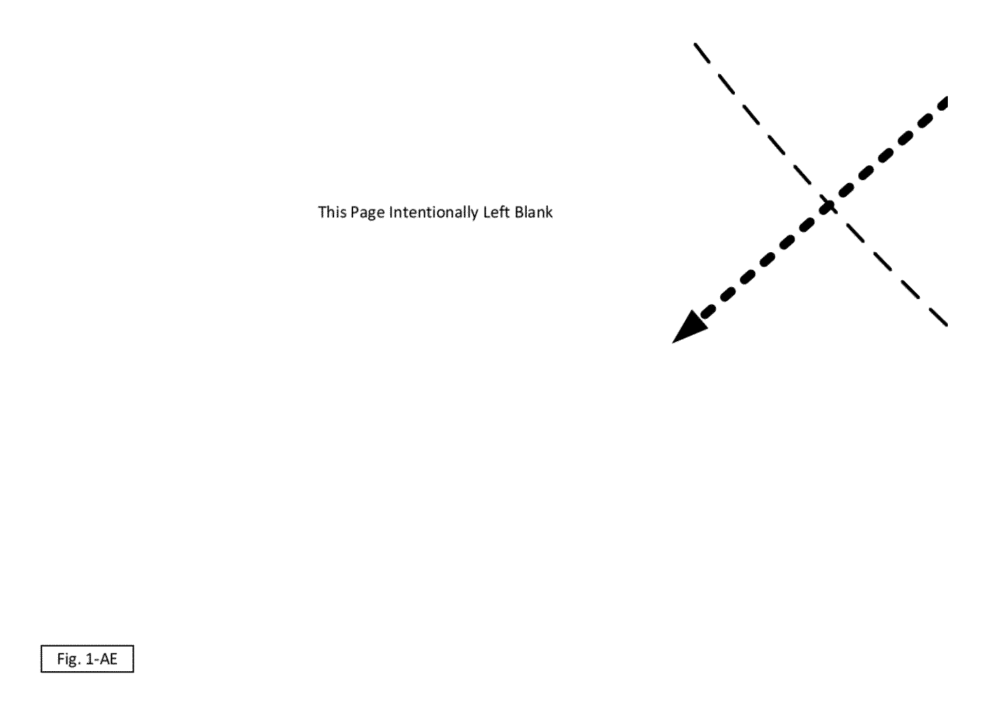

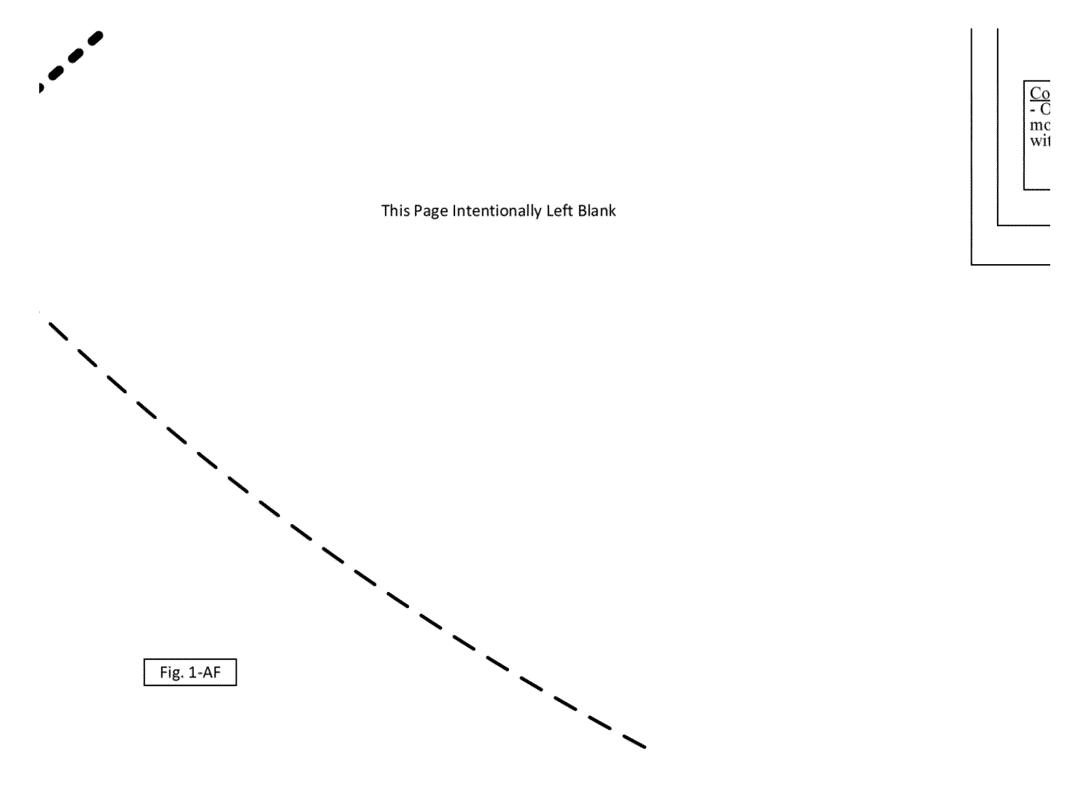

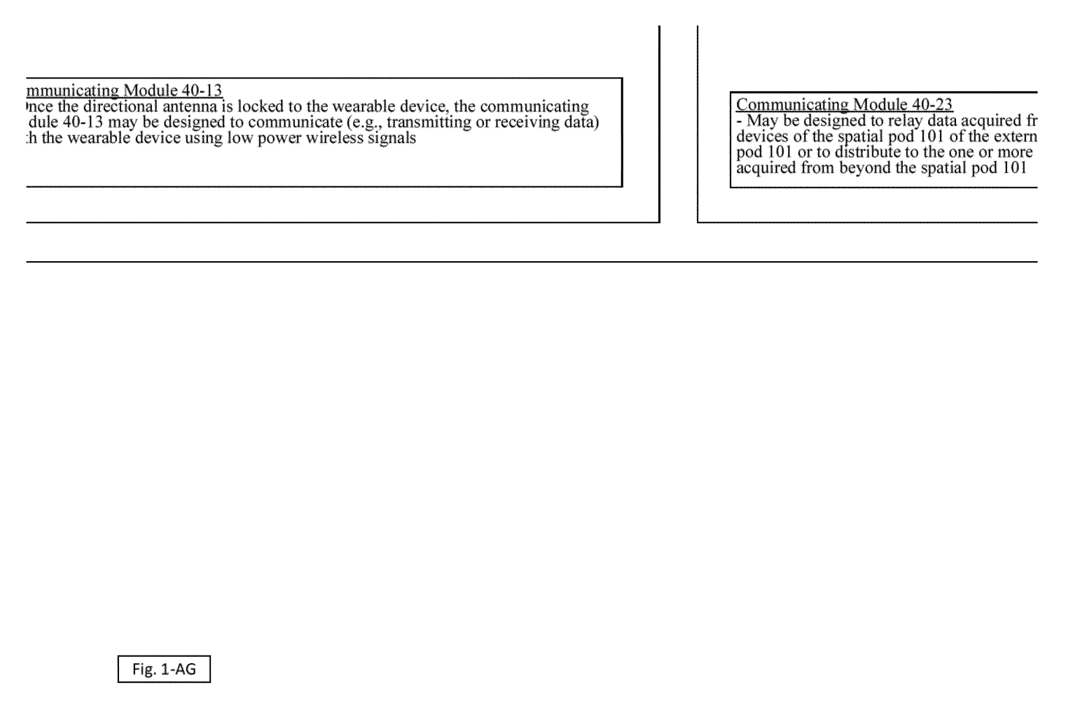

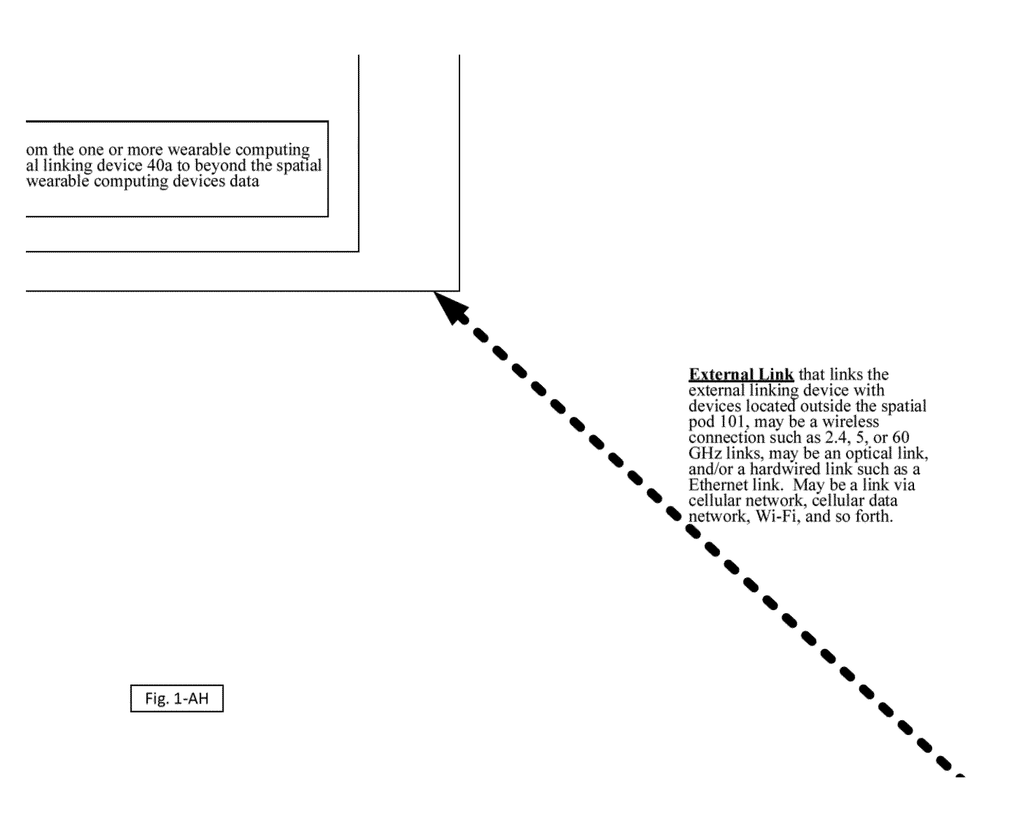

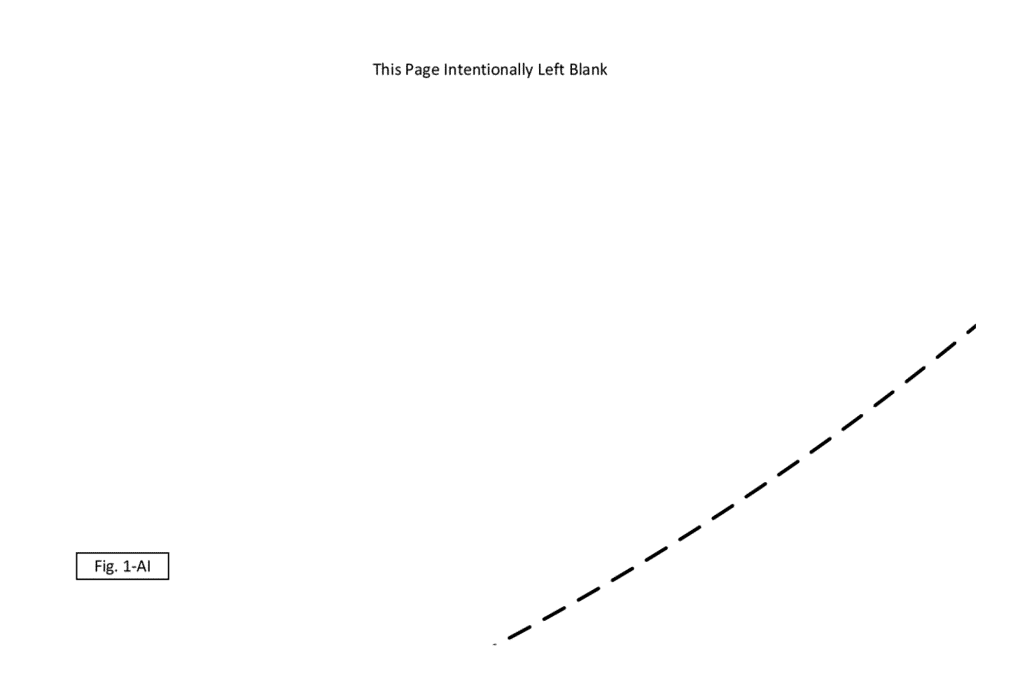

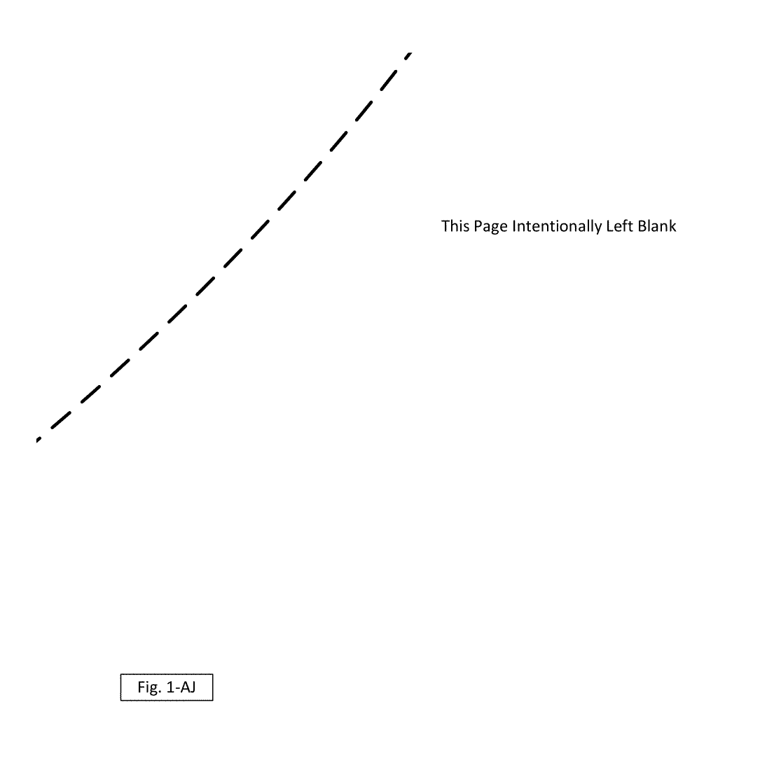

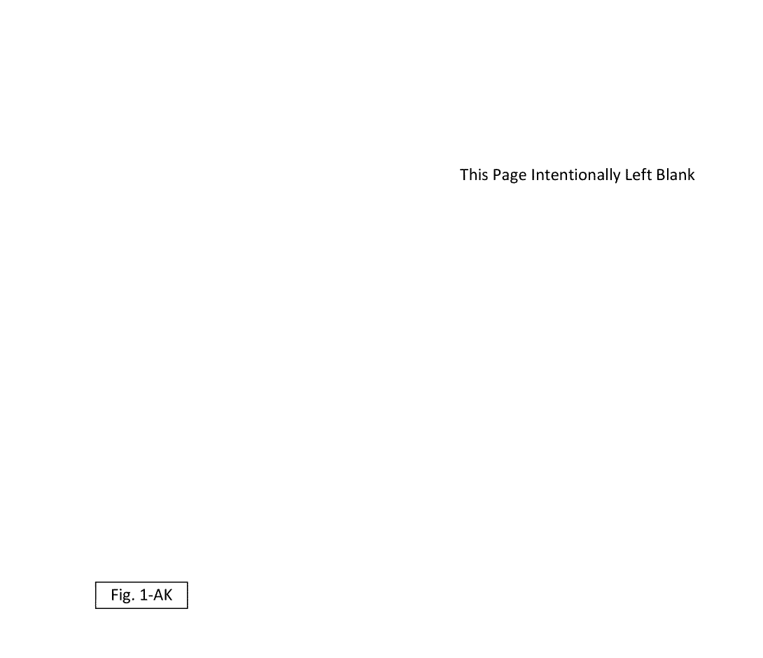

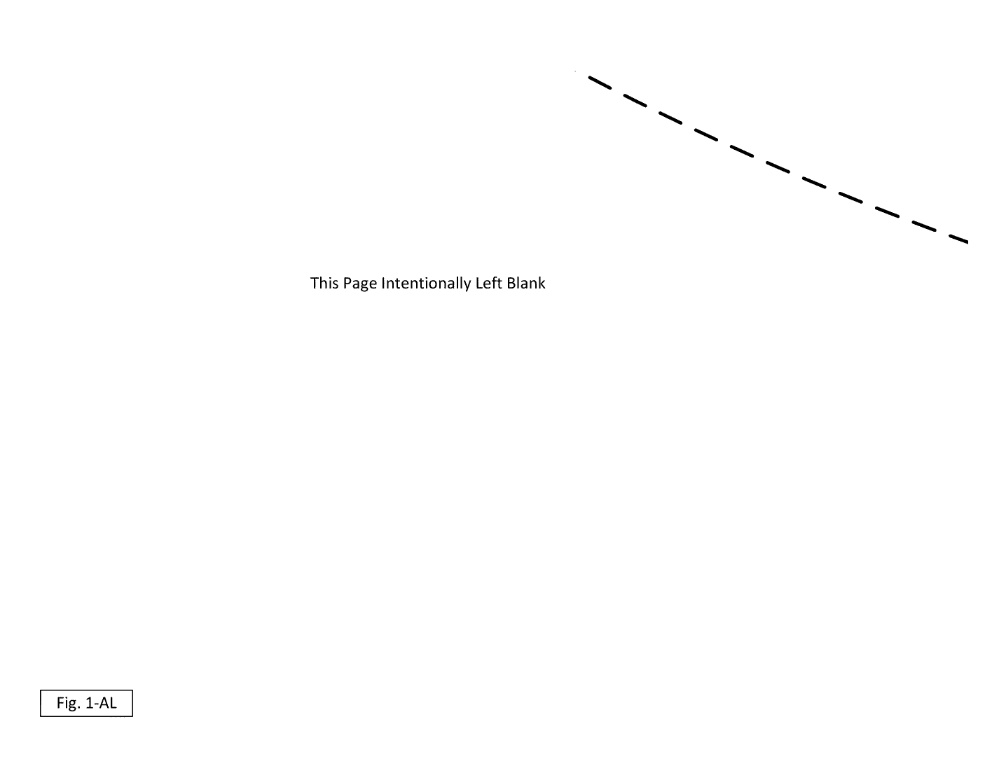

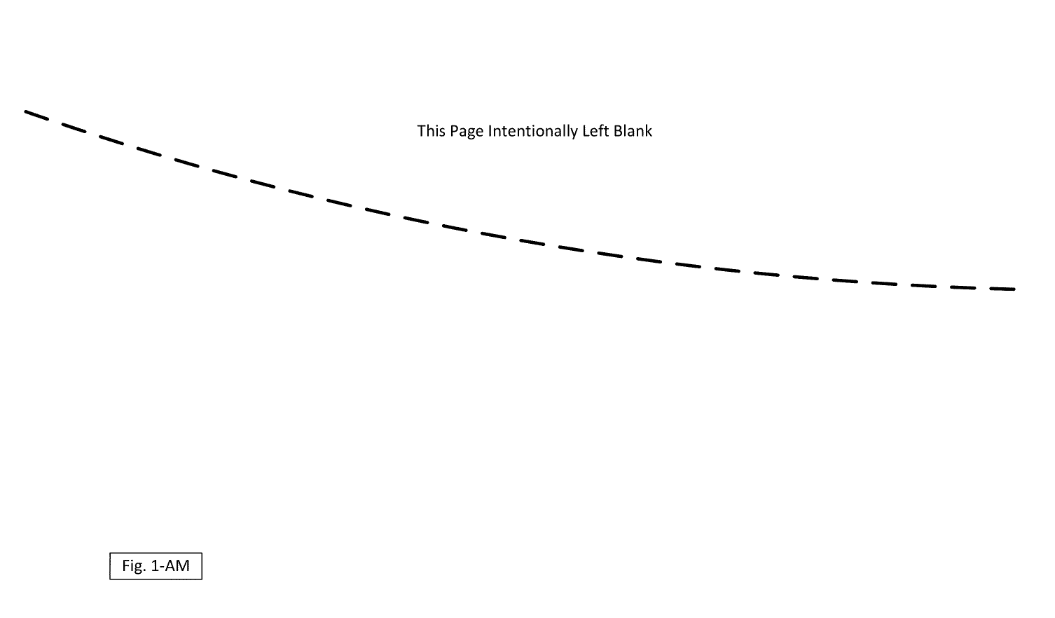

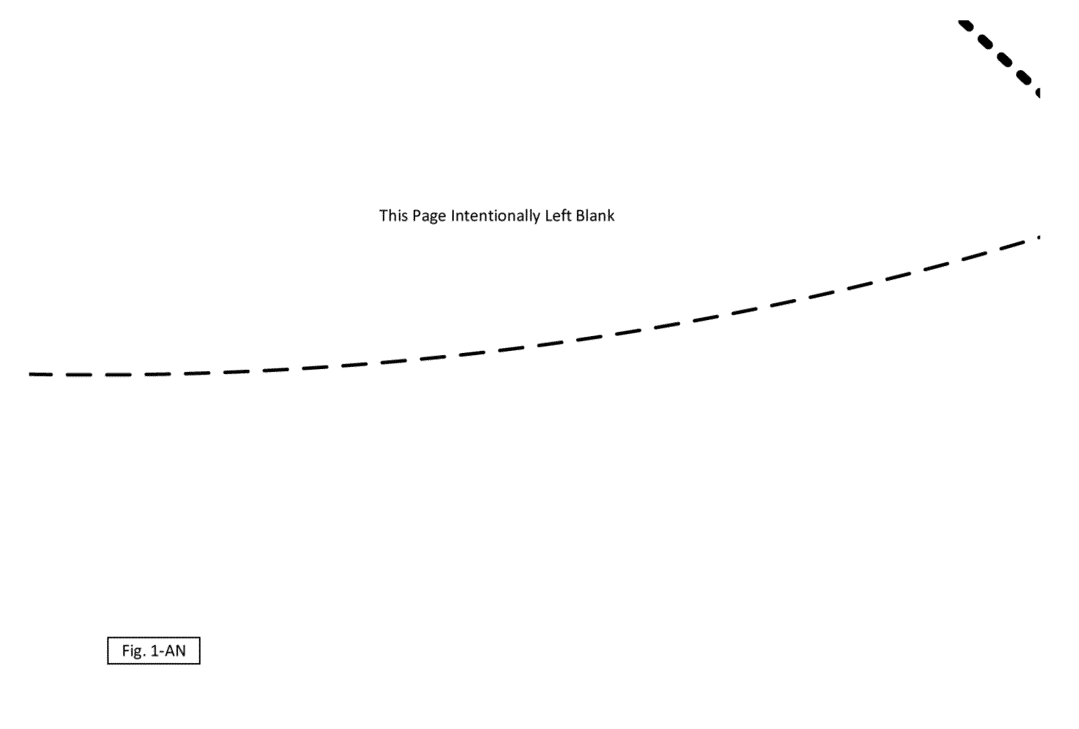

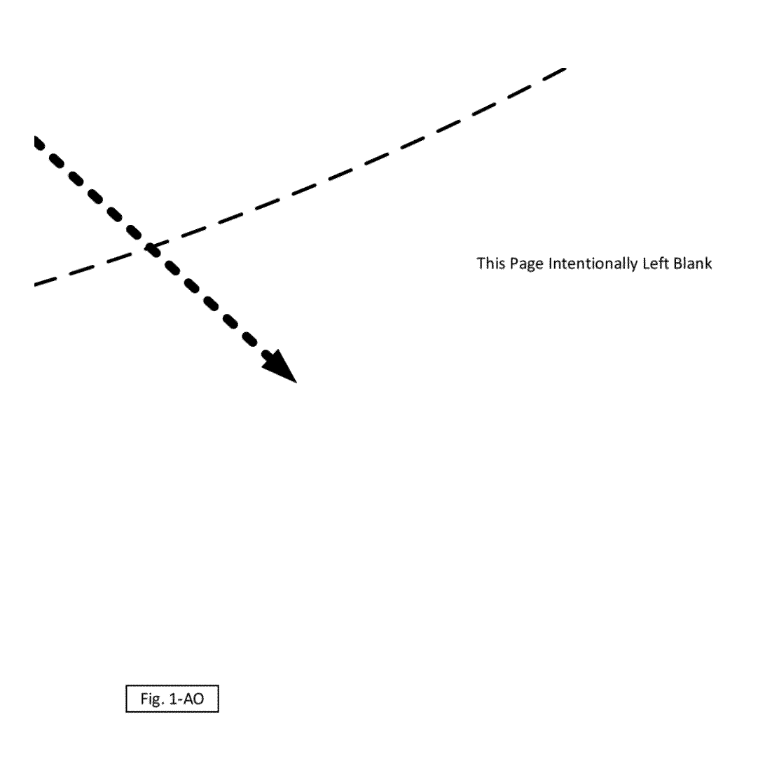

Thus, in accordance with various embodiments, computationally implemented methods, systems, circuitry, articles of manufacture, ordered chains of matter, and computer program products are designed to, among other things, provide one or more wearable computing devices for the environment illustrated in FIG. 1.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic, etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-levelprogramming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include, but are not limited to, a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, application programs, one or more interaction devices (e.g., a touch pad, a touch screen, an antenna, etc.), and/or control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and application programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, application programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server. The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

To the extent that formal outline headings are present in this application, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings and/or descriptions of single topics may span two or more topic headings). Hence, any use of formal outline headings in this application is for presentation purposes, and is not intended to be in any way limiting.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

Although one or more users maybe shown and/or described herein, e.g., in FIG. 1, and other places, as a single illustrated figure, those skilled in the art will appreciate that one or more users may be representative of one or more human users, robotic users (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

The rapid advancement and miniaturization of integrated circuitry and microelectronics over the last three decades have greatly facilitated those in the mobile computing industry to develop amazingly sleek and functionally powerful computing/communication devices, from the original clunky brick-sized portable telephones to today's sleek cellular telephones and Smartphones, and from yesterday's bulky laptops to today's sleek tablet computers and e-readers. Many believe that the next step in the evolution of mobile computing is the development of wearable computing devices. That is, there are currently multiple efforts by various groups of the high tech industry trying to develop computing/communication devices in the form of wearable computing devices that can be worn by people. Examples of such wearable computing devices include, for example, augmented reality (AR) devices having the form of glasses or goggles, and computerized watches (herein “Smartwatches”) that can provide various functionalities beyond simple time/chronograph functionalities including, for example, at least some communication capabilities (e.g., connectivity to Wi-Fi or cellular networks) and capabilities for executing applications.

Although the recent advancements in the fields of integrated circuitry and microelectronics (e.g., microprocessors) make the eventual implementation of wearable computing devices a likely inevitability, developers of such devices still face a number of hurdles that may prevent such devices from being able to provide the same type of functionalities that larger mobile devices (e.g., Smartphones, tablet computers, and so forth) can provide. One of the problems faced by developers of wearable computing devices is to try to cram into such devices all of the components that may be necessary in order to provide the same functionalities provided by larger mobile devices. For example, because a wearable computing device (e.g., an AR device or a Smartwatch) is to be worn by a user, it is generally preferable that such a wearable computing device has a relatively small form factor and be relatively lightweight. As a result, such a device may only accommodate small and/or limited number of core components including a power storage device (e.g., batteries) that is relatively small (and as a result, with limited power storage capabilities) and light, and a relatively small communication system (e.g., a communication system that employs a small and/or limited number of antennas).

In addition, it may be difficult to incorporate into such wearable computing devices other components that are typically found in larger mobile devices (e.g., Smartphones and tablet computers). For example, it may not be practical, if not undesirable, to include into such wearable computing devices functional components that are commonly found in larger mobile devices but that may not be practical to include into a wearable computing device. For instance, it may be difficult to incorporate into small wearable computing device a global positioning system (GPS) that generally requires a relatively large antenna, or sensors such as cameras and other types of sensors that can occupy large space. Also, because such wearable computing devices will be located somewhere on or adjacent to the body of a user, it will be generally desirable to employ a communication system that emits relatively low electromagnetic radiation at least towards the user's body.

In various embodiments, systems, articles of manufacture and methods are provided herein that allow small form-factor wearable computing devices to seamlessly provide the same or similar functionalities as those that may be provided by larger mobile computing devices. In some embodiments, the wearable computing devices may be in the form of a watch or bracelet, or in the form of eyewear such as glasses or goggles.

With reference now to the Figures and with reference now to FIG. 1, FIG. 1 shows a partially schematic diagram of an environment(s) and/or an implementation(s) of technologies described herein. It is noted that FIG. 1 is a high-level environment diagram that includes an overall system 100 in which at least one wearable computing device (e.g., a Smartwatch 10 or an augmented reality (AR) device 20) seeks out or queries one or more nearby devices (e.g., one or more other wearable computing devices and/or one or more external linking devices 40*) located within a spatial pod 101 surrounding the wearable computing device in order to obtain one or more functionalities from the one or more of the nearby devices. For example, in some embodiments, a wearable computing device may seek out or query one or more external linking devices 40* in order to communicate beyond the spatial pod 101 that surrounds the wearable computing device (e.g., the Smartwatch 10 or the AR device 20). Note that in the following, “*” represents a wildcard. Thus, references in the following description to, for example, an external linking device 40* may be in reference to external linking device 40a, external linking device 40b, or to external linking device 40c.

In various embodiments, a wearable computing device may be a computing device that can be worn by a user. In some cases, this means that a wearable computing device will include at least one component for coupling the wearable computing device to at least one portion of a person's body. In the case of a Smartwatch 10, for example, a wristband or armband is included as part of the Smartwatch 10, and in the case of an AR device 20, a pair of temples that is coupled to the eyeglasses frame and extend over and/or behind the ears to help hold the frame in place.

Note that FIG. 1 illustrates both perspective views of a Smartwatch 10, an AR device 20, and a Smartbracelet 30, as well as block diagrams of the Smartwatch 10, the AR device 20, the Smartbracelet 30, and external linking devices 40* that may be included in a spatial pod 101 surrounding one of the wearable computing devices (e.g., the Smartwatch 10 or the AR device 20) illustrated in FIG. 1. In order to facilitate understanding of various aspects of the Smartwatch 10, the AR device 20, and an external linking device 40*, the block diagrams of the Smartwatch 10, the AR device 20, and an external linking device 40a depicted in FIG. 1 are illustrated as having certain logic modules that may be employed in order to implement the various implementations of the Smartwatch 10, the AR device 20 and external linking device 40a.

In some embodiments, a spatial pod 101 of a wearable computing device may be in reference to a volume of space that surrounds the wearable device (e.g., a Smartwatch 10 or an AR device 20) and that may be defined by an enveloping boundary, where low-power signal generated by the wearable device being discernible over background noise within the enveloping boundary and not discernible over background noise outside the enveloping boundary. In some embodiments, a “low-power” signal, as referred to herein, may be a wireless signal that is generating with less than 1 milliwatt of power. For example, in some cases a low-power signal may be a wireless signal generated using less than 0.8 milliwatt, less than 0.6 milliwatt, less than 0.5 milliwatt, less than 0.3 milliwatt, and so forth.

In some embodiments, a spatial pod 101 of a wearable computing device that surrounds the wearable computing device may be defined by distance. For example, in some embodiments, a spatial pod 101 of a wearable computing device may be a volume of space immediately surrounding the wearable computing device (e.g., a Smartwatch 10 or an AR device 20) that does not extend beyond 3 feet, 6 feet, 8 feet, 9 feet, 10 feet, 12 feet, or some other short distance from the wearable device. Alternatively, a spatial pod 101 may be defined as spatial volume surrounding a wearable computing device that does not extend beyond 1 meter, 2 meters, 3 meters, or some other short distance from the wearable device.

In some embodiments, a spatial pod 101 of a wearable computing device may be a volume of space that immediately surrounds the wearable computing device and that does not extend beyond 24 feet from the wearable device, which is in contrast to a personal area network or PAN (e.g., Bluetooth) that typically has a range of around 30 to 32 feet. That is, by keeping the size of a spatial pod 101 of a wearable computing device relatively small, the power requirements for communicating within the spatial pod may be minimized. From another perspective, by reducing the power of signals transmitted by the wearable device (e.g., Smartwatch 10 or AR device 20), the size of the associated spatial pod 101 surrounding the wearable computing device may be reduced. In some cases, by keeping the spatial pod 101 of a wearable computing device relatively small, the spatial pod 101 of the wearable computing device may not overlap with adjacent spatial pods 101 associated with other wearable computing devices.

In some embodiments, the size and shape of a spatial pod 101 of a wearable computing device may be dictated by the presence of one or more spatial objects (e.g., a wall, the interior surface of a passenger cabin of a room, a cubical, a car, a bus, a boat, a plane, and so forth) in the proximity of the wearable computing device. That is, wireless signals tend to be attenuated by various solids, semi-solids, and even gaseous materials at different rates (note that the rate of attenuation of wireless signals will also typically depend on the frequency of the wireless signals be transmitted). Of course, and regardless of the material, the more “material” that a wireless signal has to travel through the greater the attenuation of the wireless signal.

An external linking device 40* may be any communication device that may be located within a spatial pod 101 of a wearable computing device (e.g., Smartwatch 10 or AR device 20) and that can communicate with the wearable computing device, as well as communicate beyond the spatial pod 101. That is, an external linking device 40* may be a computing/communication device that can act as a bridge or link for a wearable computing device for communicating beyond a spatial pod 101 that surrounds the wearable computing device. In various embodiments, an external linking device 40* may be any one of a variety of communication devices that may be found within a spatial pod 101 that surrounds a wearable device (e.g., a Smartwatch 10 or an AR device 20) and that can communicate beyond the spatial pod 101 including, for example, a router, a repeater, a server, a mobile computing device such as a cellular telephone or a Smartphone, a laptop or desktop computer, and so forth.

As indicated above, some of the elements of the various implementations of the various wearable devices (e.g., the Smartwatch 10 or the AR device 20) depicted in FIG. 1 are expressed as logic modules. The various logic modules (e.g., module 10-11, module 10-12, module 10-21, module 10-22, module 20-21, module 20-22, and so forth) illustrated in FIG. 1 may be implemented using a variety of hardware including, for example, customized circuitry such as application specific integrated circuit (ASIC) and/or programmable type hardware such as a microprocessor or a controller executing one or more programming instructions or field programmable gate array (FPGA) executing one or more programming instructions.

Turning specifically now to the Smartwatch 10 of FIG. 1. In various embodiments, the Smartwatch 10 may be designed to seek out or detect nearby presence of one or more devices (e.g., presence of one or more devices located within a spatial pod 101 surrounding the Smartwatch 10) that can provide one or more functionalities that are being sought by the Smartwatch 10. As those of ordinary skill in the art will recognize much of the following discussions related to the Smartwatch 10 are equally applicable to the AR device 20 of FIG. 1, which is another wearable computing device. That is, the various aspects to be described herein with respect to the Smartwatch 10 may also be applicable to the AR device 20 of FIG. 1. The Smartwatch 10, upon finding the one or more nearby devices that can provide the one or more desirable functionalities, may then communicate with the one or more nearby devices using, for example, low-power wireless signals in order to utilize the functionalities provided by the one or more nearby devices. For example, in some embodiments, the Smartwatch 10 may be designed to seek out (e.g., query one or more nearby devices to determine which of the one or more nearby devices can communicate beyond the spatial pod 101 of the wearable device) one or more external linking devices 40* that are located within a spatial pod 101 surrounding the Smartwatch 10 in order to facilitate the Smartwatch 10 to communicate beyond the spatial pod 101.

In some cases, if multiple external linking devices 40* are detected within the spatial pod 101 surrounding the Smartwatch 10 then the Smartwatch 10 may determine which of the multiple external linking devices 40* may best fit the specific needs of the Smartwatch 10. For example, if the Smartwatch 10 needs a Wi-Fi link rather than a cellular network link, than the Smartwatch 10 may establish a link with an external linking device 40* that provides Wi-Fi capabilities rather than an external linking device 40* that provides cellular network capabilities.

In some embodiments, the Smartwatch 10 may seek out (e.g., query) one or more nearby devices (e.g., one or more devices such as an AR device 20, a Smartbracelet 30, and/or external linking devices 40*) that are located within the spatial pod 101 surrounding the Smartwatch 10 in order to determine whether the one or more nearby devices provide one or more desirable functionalities other than the external communication links that may be provided by the one or more external linking devices 40*. Examples of the types of functionalities that may be sought in nearby devices include, for example, GPS functionalities, visual or audio functionalities (e.g., visual capabilities of an AR device 20 or a Smartbracelet 30 for capturing hand/finger gestures), software functionalities such as messaging functionalities, and so forth.

In various embodiments, the Smartwatch 10 may include only a single antenna for communicating with one or more external linking devices 40* as well as for communicating with the other devices (e.g., AR device 20 and Smartbracelet 30) that may be included in the spatial pod 101 of the Smartwatch 10 that surrounds the Smartwatch 10. That is, the Smartwatch 10 may employ only a single antenna to communicate with the other devices (e.g., external linking devices 40*, AR device 20, etc.) in the spatial pod 101 in order to utilize functionalities provided by the other devices of the spatial pod 101 and that may not be directly provided by the Smartwatch 10. Further, by including only a single antenna, the size of the communication system included in the Smartwatch 10 may be minimized.

In some embodiments, in order to communicate with one or more other devices in the spatial pod 101, the Smartwatch 10 may transmit/receive wireless signals at specific frequencies including transmitting/receiving 2.4, 5.0, or 60 GHz band signals. Further, in order to keep the spatial pod 101 relatively small (e.g., a spatial pod 101 that has external boundary that is no more than, for example, 6 to 24 feet, for example, away from the Smartwatch 10), the Smartwatch 10 may transmit wireless signals at less than 1 milliwatt of power (e.g., transmit at less than 0.8 milliwatt, 0.5 milliwatt, 0.4 milliwatt, and so forth, of power).

In various embodiments, the Smartwatch 10 may employ any one of a variety of antennas. For example, in some embodiments, the Smartwatch 10 may employ a directional antenna for communicating with other devices within the spatial pod 101 of the Smartwatch 10 that surrounds the Smartwatch 10. For these embodiments, the directional antenna that is employed may be a metamaterial antenna (see, for example, U.S. Patent Application Pub. No. 2012/0194399, which is hereby incorporated by reference). Other types of directional antennas may also be employed in alternative embodiments including, for example, Yagi-Uda antenna, log-periodic antenna, corner reflector antenna, and so forth. In some cases, the use of a directional antenna rather than, for example, an omnidirectional antenna may reduce the power requirements for transmitting a signal. In order to communicate with other devices (e.g., one or more external linking devices 40*, an AR device 20, and so forth) that are located within the spatial pod 101 of the Smartwatch 10, the Smartwatch 10 or at least the logic for the Smartwatch 10 may employ an algorithm (see, for example, U.S. Pat. No. 7,929,914, which is hereby incorporated by reference) for searching and finding devices that are in the proximity (e.g., spatial pod 101) of the Smartwatch 10. By employing a directional antenna and a searching algorithm for finding/locating other devices in the spatial pod 101 relative to the Smartwatch 10, the power requirements for transmitting signals to the other devices in the spatial pod 101 may be minimized or reduced. Further, by using a directional antenna, the exposure of the user of the Smartwatch 10 (e.g., a user who is wearing the Smartwatch 10) to electromagnetic radiation may be reduced/minimized.

In some alternative implementations, the Smartwatch 10 may employ an omnidirectional antenna to communicate with other devices (e.g., one or more external linking devices 40*, an AR device 20, a Smartbracelet 30, and so forth) that may be present in the spatial pod 101 that surrounds the Smartwatch 10. Examples of omnidirectional antennas that may be incorporated into the Smartwatch include, for example, dipole antenna (e.g., a folded dipole, short dipole, cage dipole, and bow-tie antenna), monopole antenna such as a Rubber Ducky antenna, halo antenna, microstrip antenna including a patch antenna, a patch array antenna, a collinear antenna, a metamaterial antenna, and so forth.

In some embodiments, the Smartwatch 10 may employ an antenna that is less than a half or quarter wavelength long of the signals transmitted by the antenna. For example, if the Smartwatch 10 transmits 2.4 GHz wireless band signals, then the wavelength of the 2.4 GHz wireless signals to be transmitted is 0.125 meters or 4.92 inches. Thus, if the Smartwatch 10 is transmitting 2.4 GHz wireless band signals then the Smartwatch 10 may employ an antenna that is less than a quarter wavelength long—that is less than 1.23 inches long (e.g., 4.92 inches/4=1.23 inches). If the wireless signals being transmitted by the Smartwatch 10 is 5.0 GHz wireless band signals then the corresponding wavelength would be 2.36 inches and the length of the antenna is less than 0.59 inches long (e.g., 2.36 inches/4=0.59 inches).

In some embodiments where a dipole antenna is being employed by the Smartwatch 10, the length of the dipole antenna is less than half the wavelength of the signals being transmitted by the dipole antenna. For example, if the wireless signals to be transmitted by the Smartwatch 10 is a 5.0 GHz band signal, the wavelength would be 2.36 inches long and the length of the dipole antenna is less than 1.18 inches long (e.g., 2.36 inches/2=1.18 inches)—in some cases substantially less than 1.18 inches long such as less than 0.59 inches.

The block diagram of the Smartwatch 10 illustrated in FIG. 1 shows some of the various possible implementations of the Smartwatch 10. Note that the implementations (e.g., implementation 10-1, implementation 10-2, implementation 10-3, and implementation 10-4) of the Smartwatch 10 depicted in FIG. 1 are not necessary mutually exclusive and in some cases may overlap. Implementation 10-1 is an implementation of the Smartwatch 10 that includes certain logic modules related to operations for seeking (e.g., searching or querying for) one or more nearby devices (e.g. one or more devices located nearby within a spatial pod 101 surrounding the Smartwatch 10) that are determined to be able to provide one or more functionalities (e.g., being able to communicate beyond the spatial pod 101, hand/finger gesture detecting functionalities, GPS functionalities, and so forth) that the Smartwatch 10 may not be able to independently provide but may need in order to execute, for example, one or more applications.

As illustrated in FIG. 1, implementation 10-1 of the Smartwatch 10 may include one or more particular logic modules including a detecting module 10-11, a functional capabilities determining module 10-12, a device selecting module 10-13, a communication link establishing module 10-14, and/or a functional capability acquiring module 10-15. In various embodiments, the detecting module 10-11 may be configured to detect presence of one or more nearby devices (e.g., AR device 20, a Smartbracelet 30, and/or one or more external linking devices 40*) within a spatial pod 101 surrounding the Smartwatch 10 and that may be designed to provide one or more functionalities (e.g., communication capabilities beyond the spatial pod 101, provide sensing capabilities including GPS, and so forth) that may not be provided by the Smartwatch 10. In various embodiments, a spatial pod 101 that surrounds the Smartwatch 10 may be in reference to a volume of space that surrounds the Smartwatch 10 (e.g., a wearable computing device) and that may be defined by an enveloping boundary, where low-power signal generated by the Smartwatch 10 being discernible over background noise within the enveloping boundary and not discernible over background noise outside the enveloping boundary. In some embodiments, a “low-power signal” is a wireless signal generated by an antenna with less than 1 milliwatt of power (e.g., 0.8 milliwatt, 0.5 milliwatt, 0.4 milliwatt, and so forth).

The functional capabilities determining module 10-12, in contrast, may be a module that is configured to determine one or more functional capabilities of the one or more detected nearby devices (e.g., AR device 20, a Smartbracelet 30, and/or one or more external linking devices 40*) including, for example, determining external communication capabilities of the one or more detected nearby devices to communicate beyond the spatial pod 101, determining availably of applications that the detected nearby devices may have in order to handle certain types of messages such as text messages, determining whether the detected nearby devices have visual or some other sensing capabilities to detect hand/finger gestures of the user, and so forth. In some embodiments, the functional capabilities determining module 10-12 may determine the functional capabilities of the one or more detected nearby devices by querying the one or more detected nearby devices. In some cases, the functional capabilities determining module 10-12 may be designed to, upon determining functional capabilities of the one or more detected nearby devices, determine (query) the availability of functional capabilities of the one or more detected nearby devices (e.g., whether such functional capabilities are currently available or not available because such functional capabilities are currently being used).

The device selecting module 10-13 may be configured to select, when a plurality of devices are detected nearby within the spatial pod 101 of the Smartwatch 10, at least one of the plurality of detected nearby devices for executing one or more functionalities based on the functional capabilities of the detected nearby devices and/or other factors including which of the detected nearby devices are closer or further away from the Smartwatch 10 (e.g., closer devices are more desirable since it may require less power to communicate with closer devices). For example, if multiple devices (e.g., external linking devices 40*) are detected nearby in the spatial pod 101 surrounding the Smartwatch 10 that were each determined to have capabilities to communicate beyond the spatial pod 101, then the device selecting module 10-13 may select at least one of the detected nearby devices for communicating beyond the spatial pod 101 based on whether the detected nearby devices have, for example, Wi-Fi capabilities or cellular network capabilities or whether for example the detected nearby devices have capabilities for processing particular types of text or instant messages.

Communication link establishing module 10-14 may be configured to establish one or more communication links (e.g., via handshake) with the one or more detected (as detected by the detecting module 10-11) and/or selected (as selected by the device selecting module 10-13) nearby devices in order to utilize one or more functionalities provided by the nearby devices.

As further illustrated in FIG. 1, in some embodiments, implementation 10-1 of the Smartwatch 10 may additionally or alternatively include a functional capability acquiring module 10-15 configured to communicate (e.g., transmit and/or receive) data with the one or more detected (as detected by the detecting module 10-11) and/or selected (as selected by the device selecting module 10-13) nearby devices that were detected nearby the Smartwatch 10 within the spatial pod 101. In some cases, the data transmitted and/or received by the functional capability acquiring module 10-15 may be associated with one or more applications that may be executed by the Smartwatch 10. Note that implementation 20-1 of the AR device 20 mirrors the implementation 10-1 of the Smartwatch 10 of FIG. 1. That is implementation 20-1 of the AR device 20, as illustrated, includes a detecting module 20-11, a functional capabilities determining module 20-12, a device selecting module 20-13, a communication link establishing module 20-14, and/or a functional capability acquiring module 20-15 that mirrors the detecting module 10-11, the functional capabilities determining module 10-12, the device selecting module 10-13, the communication link establishing module 10-14, and/or the functional capability acquiring module 10-15 of the implementation 10-1 of the Smartwatch 10.

In contrast to implementation 10-1, implementation 10-2 of the Smartwatch 10 is directed to an embodiment of the Smartwatch 10 in which the Smartwatch 10 includes a directional antenna such as a metamaterial antenna. In some cases, employment of a directional antenna rather than other types of antennas such as an omnidirectional antenna may reduce the power requirements for communicating with one or more devices that are nearby the Smartwatch 10 within the spatial pod 101 surrounding the Smartwatch 10. As illustrated in FIG. 1, implementation 10-2 of the Smartwatch 10 may include one or more particular logic modules including, for example, a location/direction determining module 10-21, an orienting/locking module 10-22, and/or a communicating module 10-23.

As illustrated in FIG. 1, the location/direction determining module 10-21 may be designed to determine the location and/or direction of one or more external linking devices 40* and/or one or more other devices (e.g., AR glasses 20 and/or Smartbracelet 30) with respect to the location of the Smartwatch 10. This may be accomplished by incrementally scanning proximity of the Smartwatch 10 with the directional antenna in order to detect signals transmitted by the one or more external lining devices 40* and/or one or more other devices (e.g., AR device 20 and/or Smartbracelet 30).

In contrast, the orienting/locking module 10-22 may be designed to orient/lock (e.g., point and/or memorialize) the directional antenna towards the detected location or locations of the one or more external lining devices 40* and/or one or more other devices (e.g., AR glasses 20 and/or Smartbracelet 30). For example, if multiple devices that provide desirable functionalities are detected near the Smartwatch 10 (e.g., detected within the spatial pod 101 of the Smartwatch 10) then locking onto the multiple detected devices by, for example, re-orienting the directional antenna between the different detected locations of the detected devices. Alternatively, orienting the “beam” or the “field of regard” (see U.S. Pat. No. 7,929,914) of the directional antenna so that detected devices can fit all within the field of regard (or beam) of the directional antenna.

After the orienting/locking module 10-22 has oriented/locked the directional antenna to the location or locations of the one or more external linking devices 40* and/or one or more other devices (e.g., AR device 20 and/or Smartbracelet 30), the communicating module 10-23 may communicate (e.g., transmit and/or receive) data with the one or more external linking devices 40* and/or one or more other devices. In some embodiments, the data that is relayed between the Smartwatch 10 and the one or more external linking devices 40* and/or one or more other devices may be data associated with one or more applications that may be executed by the Smartwatch 10. In some cases, the communicating module 10-23 of implementation 10-2 may be the same as the functional capability acquiring module 10-15 of implementation 10-1. Note that implementation 20-2 of the AR device 20 mirrors the implementation 10-2 of the Smartwatch 10 of FIG. 1 since both are wearable devices and implementation 10-2 (as well as implementation 20-2) can be implemented on either of the wearable devices (e.g., the Smartwatch 10 or the AR device 20).

In contrast to implementation 10-2, implementation 10-3 of the Smartwatch 10 is directed to an embodiment of the Smartwatch 10 in which the Smartwatch includes an antenna (e.g., a dipole or monopole antenna) that has a length less than a half wavelength or a quarter wavelength of the signals being transmitted by antenna. For example, if the signal being transmitted by the antenna is a 2.4 GHz signal (with a wavelength of 4.92 inches), then the antenna having a length less than 2.46 inches or less than 1.23 inches. As illustrated in FIG. 1, implementation 10-3 of the Smartwatch 10 may include one or more particular logic modules including, for example, a data acquiring module 10-31, a data processing module 10-32, and/or a data communicating module 10-33.

As illustrated in FIG. 1, the data acquiring module 10-31 may be designed to acquire data for transmission beyond the spatial pod 101 by an external linking device 40*, the special pod 101 being a volume in space that includes the Smartwatch 10 and the external linking device 40* and being defined by an enveloping boundary, where low-power signal (e.g., less than 1 milliwatt such as less than 0.6 milliwatt) generated by the Smartwatch 10 being discernible over background noise within the enveloping boundary and not discernible over background noise outside the enveloping boundary. In some embodiments, the data to be acquired may be inputted by a user through the Smartwatch 10 including a textual or voice message. Alternatively, the data to be acquired may be acquired from one or more applications that automatically provided the data.

In contrast to the data acquiring module 10-31, the data processing module 10-32 may be designed to process data received from beyond the spatial pod 10 via an external linking device 40*. In some cases, the data to be processed may be processed by one or more applications being implemented by the Smartwatch 10 including, for example, a messaging application such as an instant messaging application or text messaging application, a gaming application, a personal information manager application (e.g., Microsoft's Outlook), and so forth.

As further illustrated in FIG. 1, implementation 10-3 of the Smartwatch 10 may further include a data communicating module 10-33 that is designed to communicate (e.g., transmit or receive) one or more signals with the external linking device 40*, the one or more signals to be transmitted or received including at least one signal having a specific wavelength, and the transmitting/receiving antenna having a length that is less than a quarter length of the specific wavelength of the at least one signal, and the signal to be transmitted or received embodying the data to be acquired or processed through the data acquiring module 10-31 or the data processing module 10-32. Note that implementation 20-3 of the AR device 20 mirrors the implementation 10-3 of the Smartwatch 10 including the same or similar logic modules included in implementation 10-3.

FIG. 1 further illustrates implementation 10-4 for Smartwatch 10, which is an embodiment of the Smartwatch 10 in which the Smartwatch 10 seek out nearby devices that can provide one or more functionalities for detecting one or more finger and/or hand gestures of the user, and to link up with the nearby devices in order to obtain data indicative of the hand and/or finger gestures of the user. In various embodiments, implementation 10-4 of the Smartwatch 10 may include one or more logic modules including a functionally capable device finding module 10-41, a link establishing module 10-42, and/or a finger/hand/arm gesture data acquiring module 10-43.

As illustrated in FIG. 1, the functionally capable device finding module 10-41 may be designed to find (e.g., search for) one or more nearby devices (e.g., the AR device 20, the Smartbracelet 30, and/or the one or more external linking devices 40*) within the spatial pod 101 of the Smartwatch 10 that provides one or more functionalities (e.g., one or more cameras and/or one or more sensors for detecting electrical impulses of tendon/muscle movements) for detecting one or more finger/hand/arm gestures of a user wearing, for example, the Smartwatch 10. In some cases, the search for one or more nearby devices having the one or more desired functionalities may involve initially detecting the one or more nearby devices then querying the one or more detected nearby devices to determine that one or more detected nearby devices can provide the one or more desired functionalities.

In contrast, the link establishing module 10-42 may be designed to establish one or more links (e.g., communication links) with the one or more found nearby devices having the one or more functionalities. In some cases, the one or more links to the one or more nearby devices may be established by employing a handshake protocol.

The finger/hand/arm gesture data acquiring module 10-43, on the other hand, may be designed to acquire from the one or more found nearby devices data indicative of one or more hand/finger/arm gestures made by the user. In some cases, such data may be solicited from the one or more found nearby devices. In some embodiments, the data to be acquired may be raw sensor data such as raw visual data of hand/finger/arm gestures captured by a camera or raw data of detected electrical impulses of tendon and/or muscle movements in the arm or wrist of the user. Note that implementation 20-4 of the AR device 20 mirrors the implementation 10-4 of the Smartwatch 10 including the same or similar logic modules included in implementation 10-4. Note that the various logic modules illustrated for the various implementations (e.g., implementation 10-1, 10-2, and so forth) of the Smartwatch 10 may represent only some of the logic modules that may be needed in order to implement the various implementations.

Note that with respect to the AR device 20 of FIG. 1, the AR device 20 is another wearable computing device 10 that, in some respects, is similar to the Smartwatch 10. That is, in some cases, the AR device 20 may be implemented in the same way as the Smartwatch 10 may be implemented (see, for example, implementations 20-1, 20-2, and so forth of the AR device 20 as compared to implementations 10-1, 10-2, and so forth of the Smartwatch 10).

Referring now to the external linking device 40a of FIG. 1. In various embodiments, one or more external linking devices 40* including the external linking device 40a may be within a spatial pod 101 of a wearable computing device (e.g., the AR device 20 or the Smartwatch 10 of FIG. 1). The external linking device 40a may be any one of a variety of computing/communication devices that can communicate beyond a spatial pod 101 of a wearable device including, for example, a mobile device such as a cellular or Smartphone, a laptop or desktop computer, a router, a repeater, an access point, a base station, and so forth.

In various embodiments, the external linking device 40a may include one or more antennas including a directional antenna and/or an omnidirectional antenna (which for purposes of this description may include isotropic antenna). In order to communicate with other devices in the spatial pod 101 of a wearable device (e.g., Smartwatch 10 or AR device 20), the external linking device 40a may wirelessly transmit signals at 2.4 GHz, 5.0 GHz, or 60 GHz. For example, the external linking device 40a may communicate with a wearable device (e.g., Smartwatch 10 or AR device 20) by transmitting 2.4 GHz band signals, 5.0 GHz band signals, or 60 GHz band signals to the wearable device. Note that for purposes of this description references to a 2.4 GHz band signals may be in reference to a band of signals that is centered exactly at or proximately at 2.4 GHz. The block diagram of the external linking device 40a shows a couple of the various possible implementations of the external linking device 40a.

In implementations 40-1, the external linking device 40a employs a directional antenna (e.g., a metamaterial antenna or a Yagi-Uda antenna) for at least communicating with one or more other devices (e.g., Smartwatch 10, AR device 20, Smartbracelet 30, and/or one or more other external linking devices 40*) that are within a spatial pod 101 of a wearable computing device (e.g., Smartwatch 10 or AR device 20). In implementation 40-1, the external linking device 40a may communicate with nearby devices located within the spatial pod 101 of a wearable device via 2.4 GHz band signals, 5.0 GHz band signals, 60 GHz band signals, or via other frequency band signals. In implementation 40-1 of the external linking device 40a, the external linking device 40a may include certain logic modules including, for example, a location/direction determining module 40-11, an orienting/locking module 40-12, and/or a communicating module 40-13.

In various embodiments, the location/direction determining module 40-11 may be designed to determine location/direction of one or more nearby wearable devices (e.g., Smartwatch 10 and/or AR device 20) with respect to the location of the external linking device 40a. Note that the location/direction determining module 40-11 may be designed to determine the location and/or directions of multiple wearable devices of multiple users relative to the location of the external linking device 40a in some cases. In some cases, the operations executed by the location/direction determining module 40-11 may be accomplished by incrementally scanning (e.g., incrementally moving the field of regard of the directional antenna) the proximity of the external linking device 40a with the directional antenna in order to detect signals transmitted by a wearable device (e.g., AR device 20 or Smartwatch 10). By doing so, a determination can be made as to the location or direction of the wearable device relative to the external linking device 40a.

In contrast to the location/direction determining module 40-11, the orienting/locking module 40-12 may be designed to orient and/or lock the directional antenna towards the detected locations or locations of the one or more wearable computing devices. For example, if multiple wearable computing devices are detected nearby to the external linking device 40a then the orienting/locking module 40-12 memorializes the locations of the wearable computing devices relative to the location of the external linking device 40a and locks onto the locations of the multiple wearable computing devices in order to communicate with the multiple wearable computing devices. The communicating module 40-13 is, on the other hand, designed to communicate with the one or more wearable computing devices (e.g., one or more Smartwatches 10 and/or one or more AR devices 20) after the orienting/locking module 40-12 has locked onto the location or locations of the one or more wearable computing devices. In some embodiments, the data to be transmitted and/or received to and/or from the one or more wearable computing devices may be associated with one or more applications (e.g., messaging applications, gaming applications, work productivity applications, and so forth) being executed by the one or more wearable computing devices.

In contrast to implementation 40-1, implementation 40-2 of the external linking device 40a is directed to an embodiment of the external linking device 40a in which the external linking device 40a includes an antenna (e.g., a dipole or monopole antenna) that has a length less than a half wavelength or a quarter wavelength of the band signals being transmitted by antenna. For example, if the signal being transmitted by the antenna is a 2.4 GHz signal (with a wavelength of 4.92 inches), then the antenna having a length less than 2.46 inches or 1.23 inches. As illustrated in FIG. 1, implementation 40-2 of the external linking device 40a may include one or more particular logic modules including, for example, a relaying data acquiring module 40-21, a distributing data obtaining module 40-22, and/or a communicating module 40-23.

In various embodiments, the relaying data acquiring module 40-21 may be designed to acquire data from one or more of wearable computing devices that are located within a spatial pod 101 of the external linking device 40a for relaying (transmission) beyond the spatial pod 101, the spatial pod 101 being a volume of space that includes one or more wearable devices (e.g., one or more Smartwatches 10 and/or one or more AR devices 20 associated with a single user or multiple users) and the external linking device 40a being defined by an enveloping boundary, where low-power signal (e.g., less than 0.7 milliwatt or less than 0.5 milliwatt) generated by the external linking device 40a being discernible over background noise within the enveloping boundary and not discernible over background noise outside the enveloping boundary. In various embodiments, the data to be acquired from the one or more wearable computing devices located within the spatial pod 101 being data associated with one or more applications being executed by the one or more wearable computing devices including, for example, data associated with textual or audio messaging applications (e.g., email, IM, text message, VoIP, and so forth), data associated with gaming applications, data associated with productivity applications, and so forth.

In contrast to the relaying data acquiring module 40-21, the distributing data obtaining module 40-22 may be designed to obtain from outside (e.g., beyond) the spatial pod 101 data that is to be distributed to one or more wearable computing devices in the spatial pod 101. In various embodiments, the data to be obtained may be messaging data (e.g., email, IM, text message, voice message, and so forth), gaming data, data associated with one or more productivity applications, and/or other types of data.

Finally, the communicating module 40-23 for implementation 40-2 may be designed to relay data acquired from the one or more wearable computing devices of the spatial pod 101 of the external linking device 40a to beyond (e.g., outside) the spatial pod 101 or to distribute to the one or more wearable computing devices data acquired from beyond (e.g., outside) the spatial pod 101.

In some embodiments, the external linking device 40a may communicate beyond the spatial pod 101 of the external linking device 40a by transmitting or receiving data via 2.4, 5.0, or 60 GHz band wireless signals. Alternatively, the data may be transmitted or received via optical, Ethernet, coaxial, and/or fiber optics links. In some cases, if the same type of communication link (e.g., 60 GHz wireless signals) may be used to communicate with external devices as well as internal devices (e.g., one of the wearable devices in the pod).

Turning now to the Smartbracelet 30 of FIG. 1. The Smartbracelet 30, which may be in the form of a wristband (wrist bracelet) or an armband, is an electronic device having one or more sensors (e.g., one or more cameras, electrical impulse sensors, audio sensors, and so forth) for sensing/detecting one or more characteristics of a user's body and various logic for operating the one or more sensors, as well as for processing of data acquired by the one or more sensors, and for coordinating the relaying and/or distribution of the data resulting from the sensing operations of the one or more sensors. For example, and as illustrated in FIG. 1, the Smartbracelet 30 may include various logic modules include a linking module 30-01, a sensor controlling module 30-02, a sensor data processing module 30-03, and/or a sensing results relaying module 30-04.

The linking module 30-01, as illustrated, may be designed to link up (e.g., form a communication link) with one or more nearby devices including a wearable computing device (e.g., Smartwatch 10 or AR device 20). This may further include a sub-module for receiving commands/requests from wearable computing devices to control one or more sensors. In contrast to the linking module 30-01, the sensor controlling module 30-02 may be designed to control one or more sensors including activating the one or more sensors. In various embodiments, the activation may be prompted in response to receiving via, for example, wireless signal, a command or request from a wearable computing device for activating the one or more sensors. The sensor data processing module 30-03 may be designed to process raw sensor data as provided by one or more sensors of the Smartbracelet 30 to a more usable form including in a form that may be wirelessly transmitted. The sensing results relaying module 30-04 may be designed to transmit to one or more nearby devices (e.g., wearable computing devices such as a Smartwatch 10 and/or an AR device 20) results of sensing operations performed by one or more sensors of the Smartbracelet 30. In some cases, raw sensor data may be transmitted while in other cases sensor data that has been processed may be transmitted.

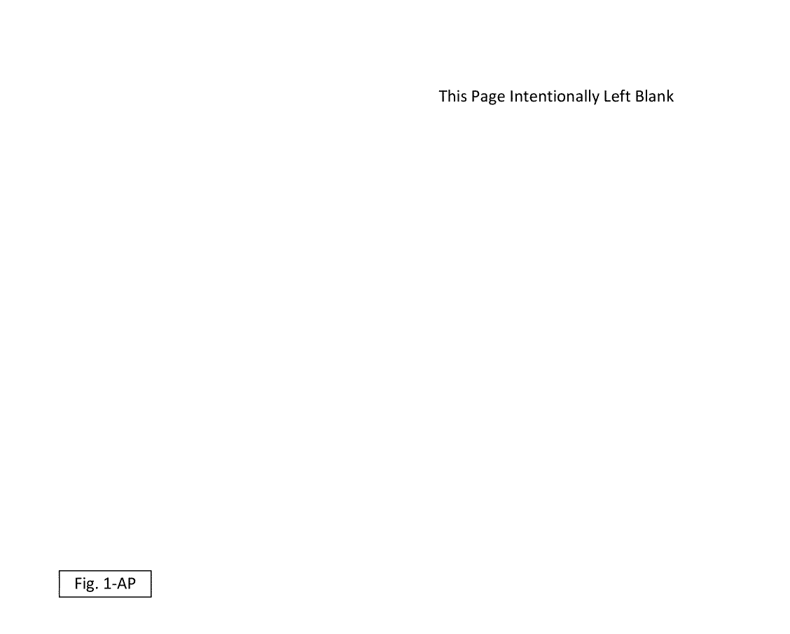

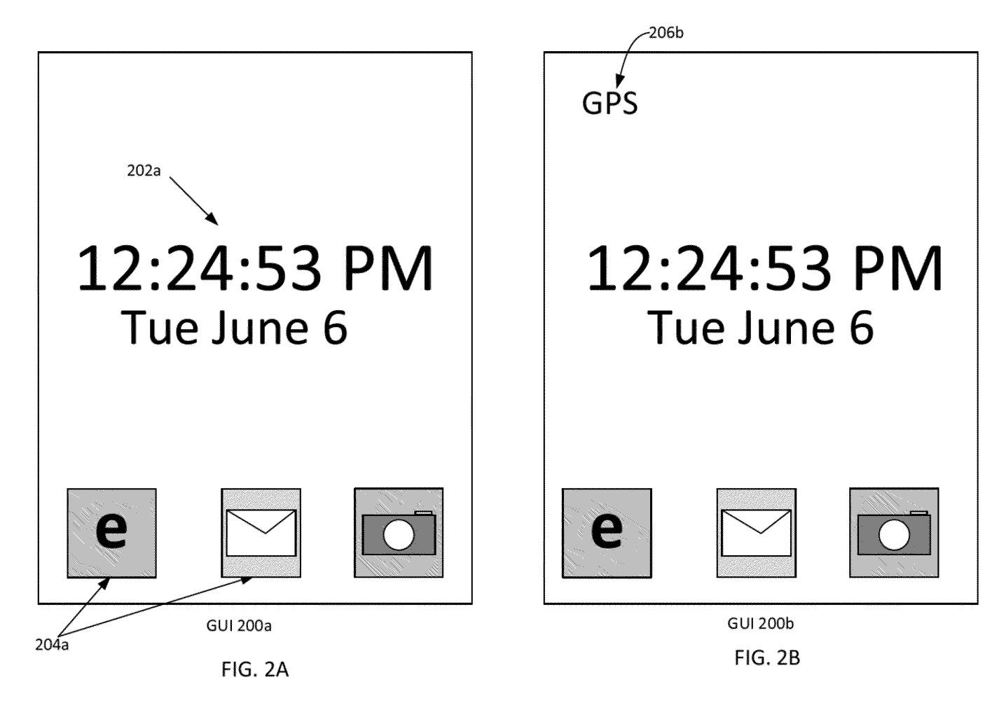

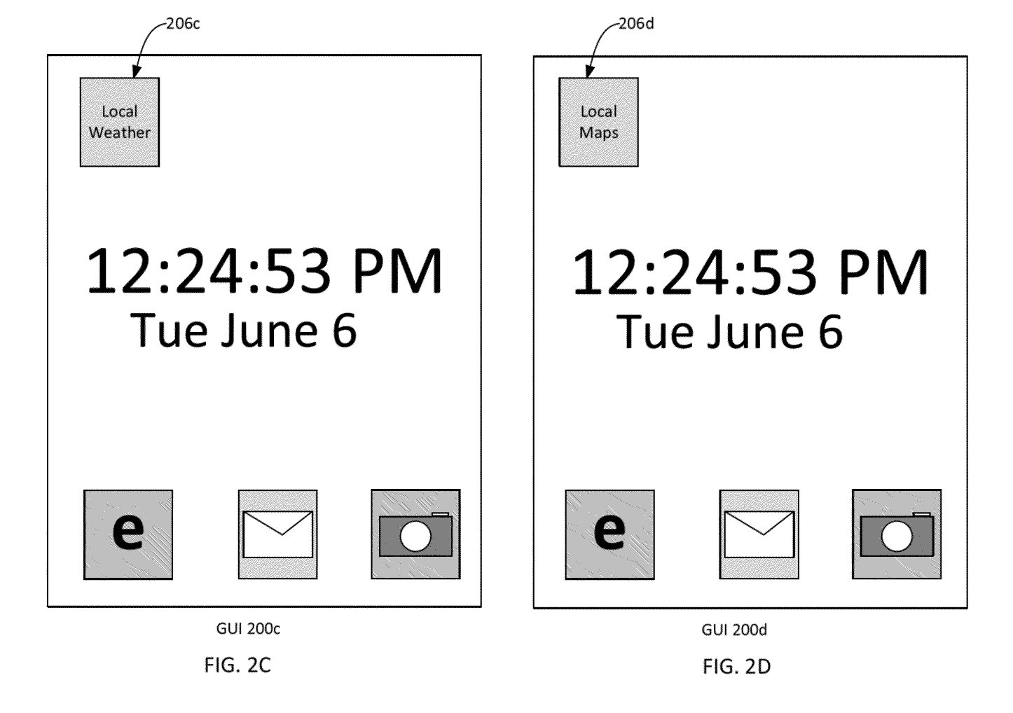

Referring now to FIGS. 2A, 2B, 2C, and 2D, which illustrate example graphical user interfaces (GUIs) that may be displayed by a wearable computing device such as the Smartwatch 10 of FIG. 1. Those of ordinary skill in the art will recognize that variations of the example GUIs of FIGS. 2A, 2B, 2C, and 2D may also be displayed through the AR device 20 of FIG. 1. Referring particularly now to FIG. 2A, which illustrates an exemplary GUI 200a which includes multiple icons 204a for various applications (e.g., a browser application, an email application, and a camera application). Also included with the GUI 200a is text 202a indicating the current time.

In various embodiments, the GUIs 200b, 200c, and 200d of FIGS. 2B, 2C, and 2D may be as a result of the associated wearable computing device (e.g., Smartwatch 10) linking up with one or more nearby devices (e.g., nearby devices such as another wearable computing device or an external linking device 40* that are within the spatial pod 101 of the wearable computing device) and obtaining one or more functionalities from the one or more nearby devices. For example, GUI 200b of FIG. 2B may be displayed by the Smartwatch 10 of FIG. 1 after the Smartwatch 10 has, for example, searched for, found, and then has linked up with a nearby device (e.g., an external linking device 40* such as a Smartphone) that provides GPS (global positioning system) functionalities. The exemplary GUI 200b includes text 206b that indicates that GPS functionality is currently available to the Smartwatch 10.

FIG. 2C illustrates yet another exemplary GUI 200c that may be displayed by the Smartwatch 10 after the Smartwatch 10 has, for example, obtained access to one or more functionalities (e.g., GPS functionality, Internet access, and/or a weather application) that is available through one or more nearby devices (e.g., one or more devices within spatial pod 101 of the Smartwatch 10). In particular, the GUI 200c provides an icon 206c that may be “clicked” by a user in order to display local weather information. Such information may not be available through the Smartwatch 10 unless, for example, the Smartwatch 10 is linked to one or more nearby devices that can provide one or more functionalities (e.g., GPS functionalities, Internet access, and/or weather application) that may be needed in order to provide such information. Thus, icon 206c, in some cases, may be displayed only after the needed functionalities are available to the Smartwatch 10.

FIG. 2D illustrates still another exemplary GUI 200d that may be displayed by the Smartwatch 10 after the Smartwatch 10 has, for example, obtained access to one or more functionalities (e.g., GPS functionality and/or a mapping application) that is available through one or more nearby devices (e.g., one or more devices within spatial pod 101 of the Smartwatch 10). In particular, the GUI 200d provides an icon 206d that may be “clicked” by a user in order to display local mapping information. Such information may not be available through the Smartwatch 10 unless, for example, the Smartwatch 10 is linked to one or more nearby devices that can provide one or more functionalities (e.g., GPS functionalities and/or mapping application) that may be needed in order to provide such information. Thus, icon 206d, in some cases, may be displayed only after the needed functionalities are available to the Smartwatch 10.

In an embodiment, a computationally-implemented method includes determining location or direction of an external linking device relative to a wearable computing device within a spatial pod, the spatial pod being a volume of space that includes the wearable computing device and the external linking device and being defined by an enveloping boundary, where low-power wireless signal generated by the wearable computing device being discernible over background noise within the enveloping boundary and not discernible over background noise outside the enveloping boundary, the wearable computing device being a computing device that is designed to be worn by a user and the external linking device being designed to communicate with the wearable computing device as well as to communicate beyond the spatial pod; pointing a directional antenna of the wearable computing device towards the external linking device based, at least in part, on said determining; and transmitting a low-power wireless signal from the wearable computing device to the external linking device using the directional antenna of the wearable computing device, the low-power wireless signal not discernible over background noise beyond the spatial pod.

In an embodiment, a computationally-implemented method includes determining location or direction of an external linking device relative to a wearable computing device within a spatial pod, the spatial pod being a volume of space that includes the wearable computing device and the external linking device and being defined by an enveloping boundary, where low-power wireless signal generated by the wearable computing device being discernible over background noise within the enveloping boundary and not discernible over background noise outside the enveloping boundary, the wearable computing device being a computing device that is designed to be worn by a user and the external linking device being designed to communicate with the wearable computing device as well as to communicate beyond the spatial pod; pointing a directional antenna of the wearable computing device at the external linking device based, at least in part, on said determining; and receiving, by the wearable computing device, a low-power wireless low-power signal from the external linking device using the directional antenna of the wearable computing device.

In an embodiment, a computationally-implemented method includes determining location or direction of a wearable computing device relative to an external linking device within a spatial pod, the spatial pod being a volume of space that includes the wearable computing device and the external linking device and being defined by an enveloping boundary, where low-power signal generated by the external linking device being discernible over background noise within the enveloping boundary and not discernible over background noise outside the enveloping boundary, the external linking device being designed to communicate with the wearable computing device as well as to communicate beyond the spatial pod; pointing a directional antenna of the external linking device at the wearable computing device based, at least in part, on said determining; and receiving a low-power signal, by the external linking device, from the wearable computing device using the directional antenna of the external linking device.

In an embodiment, a computationally-implemented method includes determining, by a wearable computing device, presence of two or more external linking devices within a spatial pod surrounding the wearable computing device, the spatial pod being a volume of space that is defined by an enveloping boundary where low-power wireless signal generated by the wearable computing device being discernible over background noise within the enveloping boundary and not discernible over background noise outside the enveloping boundary, the wearable computing device being a computing device that is designed to be worn by a user and the two or more external linking devices being designed to communicate with the wearable computing device as well as to communicate beyond the enveloping boundary of the spatial pod; selecting from the two or more external linking devices at least one external linking device to facilitate the computing device to communicate beyond the spatial pod; and communicating by the wearable computing device with at least the one external linking device order for the wearable computing device to communicate beyond the spatial pod.

In an embodiment, a computationally-implemented method includes establishing, by a wearable computing device having an antenna with a particular length, one or more communication links with one or more nearby devices located within a spatial pod of the wearable computing device, the spatial pod surrounding the wearable computing device and being a volume of space defined by an enveloping boundary, where low-power wireless signal generated by the wearable computing device being discernible over background noise within the enveloping boundary and not discernible over background noise outside the enveloping boundary, the establishing of the one or more communication links by transmitting or receiving one or more low-power signals having wavelengths that are greater than two or four times the length of the antenna; and querying the one or more nearby devices to determine whether the one or more nearby devices have one or more specific functionalities sought by the wearable computing device, the querying being performed by at least transmitting one or more signals to the one or more nearby devices having wavelengths that are greater than two or four times the length of the antenna.

In an embodiment, a computationally-implemented method includes establishing by a first wearable computing device with a second wearable computing device a wireless link, the first wearable computing device and the second wireless link being located within a spatial pod, the spatial pod being a volume of space that surrounds the first wearable computing device and that is defined by an enveloping boundary, where a low-power wireless signal generated by the first wearable computing device being discernible over background noise within the enveloping boundary and not discernible over background noise outside the enveloping boundary, and the first wearable computing device being designed to be worn around a limb of a person; and receiving, by the first wearable computing device from the second wearable computing device, visual data indicative of one or more hand gestures, the data for controlling the first wearable computing device, and the visual data received through the wireless link.

In an embodiment, a computationally-implemented method includes establishing by a first wearable computing device with a second wearable computing device a wireless link, the first wearable computing device and the second wireless link being located within a spatial pod, the spatial pod being a volume of space that surrounds the first wearable computing device and that is defined by an enveloping boundary, where a low-power wireless signal generated by the first wearable computing device being discernible over background noise within the enveloping boundary and not discernible over background noise outside the enveloping boundary, and the first wearable computing device being designed to be worn on head of a person; and transmitting, by the first wearable computing device to the second wearable computing device, visual data indicating one or more hand gestures, the data for controlling the second wearable computing device.

In an embodiment, a computationally-implemented method includes establishing wirelessly a communication link from a first wearable computing device to a second wearable computing device located within a spatial pod of the first wearable computing device, the spatial pod being a volume of space that includes the first and second wearable computing devices and being defined by an enveloping boundary, where low-power wireless signal generated by the first wearable computing device being discernible over background noise within the enveloping boundary and not discernible over background noise outside the enveloping boundary, and the first wearable computing device being designed to be worn around a head of a person and the second wearable computing device designed to be worn around a limb of the person; and receiving by the first wearable computing device from the second wearable computing device, data indicative of one or more hand gestures made by the person, the data to be received for controlling the first wearable computing device. In some cases, the data to be received by the first wearable computing device being data that was as a result of sensing one or more electrical impulses sensed from an arm or wrist of the person.

In an embodiment, a computationally-implemented method includes establishing wirelessly a communication link from a first wearable computing device to a second wearable computing device located within a spatial pod of the first wearable computing device, the spatial pod being a volume of space that includes the first and second wearable computing devices and being defined by an enveloping boundary, where low-power wireless signal generated by the first wearable computing device being discernible over background noise within the enveloping boundary and not discernible over background noise outside the enveloping boundary, and the first wearable computing device being designed to be worn around a limb of the person; and transmitting by the first wearable computing device to the second wearable computing device data indicating one or more tendon or muscle movements that indicate one or more finger or hand gestures, the data to be received for controlling the second wearable computing device.

In an embodiment, a computationally-implemented method includes querying a device that was detected within a spatial pod surrounding a wearable computing device as to whether the detected device provides a functionality not provided by the wearable computing device, the spatial pod being a spatial volume that includes the wearable computing device and being defined by an enveloping boundary, where low-power wireless signal generated by the wearable computing device being discernible over background noise within the enveloping boundary and not discernible over background noise outside the enveloping boundary; and communicating with the detected device, by the wearable computing device, in order to facilitate the wearable device to utilize the functionality provided by the detected device.

In an embodiment, a computationally-implemented method includes detecting presence of a plurality of devices within a spatial pod surrounding a wearable computing device that provides at least one functionality not provided by the wearable computing device, the spatial pod being a spatial volume that includes the wearable computing device and being defined by an enveloping boundary, where low-power wireless signal generated by the wearable computing device being discernible over background noise within the enveloping boundary and not discernible over background noise outside the enveloping boundary; selecting one of the plurality of devices for providing the functionality; and communicating with the selected device by the wearable computing device in order for the wearable computing device to utilize the functionality provided by the detected device.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Throughout this application, the terms “in an embodiment,” “in one embodiment,” “in some embodiments,” “in several embodiments,” “in at least one embodiment,” “in various embodiments,” and the like, may be used. Each of these terms, and all such similar terms should be construed as “in at least one embodiment, and possibly but not necessarily all embodiments,” unless explicitly stated otherwise. Specifically, unless explicitly stated otherwise, the intent of phrases like these is to provide non-exclusive and non-limiting examples of implementations of the invention. The mere statement that one, some, or may embodiments include one or more things or have one or more features, does not imply that all embodiments include one or more things or have one or more features, but also does not imply that such embodiments must exist. It is a mere indicator of an example and should not be interpreted otherwise, unless explicitly stated as such.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1. (canceled)

2. (canceled)

3. A computationally-implemented method, comprising:
detecting presence of one or more electronic devices near a wearable computing device that are within a spatial pod of the wearable computing device, the spatial pod of the wearable computing device being a spatial volume that includes the wearable computing device and being defined by an enveloping boundary, where low-power signals generated by the wearable computing device being discernible over background noise within the enveloping boundary and not discernible over background noise outside the enveloping boundary, the wearable computing device being a computing device designed to be worn by a user;
transmitting, by the wearable computing device, one or more low-power query signals to the one or more nearby electronic devices to query the one or more nearby electronic devices to ascertain which, if any, of the one or more nearby electronic devices provides one or more specific functionalities that are being sought by the wearable computing device;
receiving, by the one or more nearby electronic devices, the one or more low-power query signals;
transmitting to the wearable computing device, by the one or more nearby electronic devices, one or more confirmation signals that at least indicates that the one or more nearby computing device possess the one or more specific functionalities;
receiving, by the wearable computing device, the one or more confirmation signals;
obtaining, by the wearable computing device, the one or more specific functionalities from the one or more nearby electronic devices based, at least in part, on the one or more confirmation signals received by the wearable computing device; and
controlling the wearable computing device based, at least in part, results of obtaining the one or more specific functionalities.

4. The computationally-implemented method of claim 3, wherein said detecting presence of one or more electronic devices near a wearable computing device that are within a spatial pod of the wearable computing device, the spatial pod of the wearable computing device being a spatial volume that includes the wearable computing device and being defined by an enveloping boundary, where low-power signals generated by the wearable computing device being discernible over background noise within the enveloping boundary and not discernible over background noise outside the enveloping boundary, the wearable computing device being a computing device designed to be worn by a user comprises:
broadcasting, by the wearable computing device, one or more low-power prompting signals to prompt the one or more nearby electronic devices to generate one or more responsive signals in response to the one or more nearby electronic devices detecting the one or more low-power prompting signals, the one or more responsive signals when received by the wearable computing device designed to at least notify the wearable computing device that the one or more nearby electronic devices have at least detected the one or more low-power prompting signals broadcasted by the wearable computing device;
detecting, by the one or more nearby electronic devices, the one or more low-power prompting signals;
broadcasting at least towards the wearable computing device by the one or more nearby electronic devices, the one or more responsive signals; and
monitoring, by the wearable computing device, for reception of the one or more responsive signals at the wearable computing device in order to detect presence of the one or more nearby electronic devices within the spatial pod.

5. The computationally-implemented method of claim 4, wherein said broadcasting, by the wearable computing device, one or more low-power prompting signals to prompt the one or more nearby electronic devices to generate one or more responsive signals in response to the one or more nearby electronic devices detecting the one or more low-power prompting signals, the one or more responsive signals when received by the wearable computing device designed to at least notify the wearable computing device that the one or more nearby electronic devices have at least detected the one or more low-power prompting signals broadcasted by the wearable computing device comprises:
broadcasting, by the wearable computing device, the one or more low-power prompting signals by broadcasting the one or more low-power prompting signals via at least one of an omnidirectional antenna or a directional antenna.

6. The computationally-implemented method of claim 4, wherein said broadcasting, by the wearable computing device, one or more low-power prompting signals to prompt the one or more nearby electronic devices to generate one or more responsive signals in response to the one or more nearby electronic devices detecting the one or more low-power prompting signals, the one or more responsive signals when received by the wearable computing device designed to at least notify the wearable computing device that the one or more nearby electronic devices have at least detected the one or more low-power prompting signals broadcasted by the wearable computing device comprises:
broadcasting, by the wearable computing device, the one or more low-power prompting signals by broadcasting the one or more low-power prompting signals via at least one of a metamaterial antenna, a Yagi-Uda antenna, a dipole antenna, a monopole antenna, a patch antenna, a halo antenna, a microstrip antenna, a patch array antenna, or a collinear antenna.

7. The computationally-implemented method of claim 4, wherein said broadcasting, by the wearable computing device, one or more low-power prompting signals to prompt the one or more nearby electronic devices to generate one or more responsive signals in response to the one or more nearby electronic devices detecting the one or more low-power prompting signals, the one or more responsive signals when received by the wearable computing device designed to at least notify the wearable computing device that the one or more nearby electronic devices have at least detected the one or more low-power prompting signals broadcasted by the wearable computing device comprises:
broadcasting, by the wearable computing device, the one or more low-power prompting signals by transmitting wirelessly, by the wearable computing device, one or more low-power prompting signals transmitted with signal strength of less than 0.8 milliwatt.

8. The computationally-implemented method of claim 4, wherein said broadcasting, by the wearable computing device, one or more low-power prompting signals to prompt the one or more nearby electronic devices to generate one or more responsive signals in response to the one or more nearby electronic devices detecting the one or more low-power prompting signals, the one or more responsive signals when received by the wearable computing device designed to at least notify the wearable computing device that the one or more nearby electronic devices have at least detected the one or more low-power prompting signals broadcasted by the wearable computing device comprises:
broadcasting, by the wearable computing device, the one or more low-power prompting signals by transmitting wirelessly, by the wearable computing device, one or more low-power prompting signals transmitted with signal strength of less than 0.5 milliwatt.

9. The computationally-implemented method of claim 4, wherein said broadcasting, by the wearable computing device, one or more low-power prompting signals to prompt the one or more nearby electronic devices to generate one or more responsive signals in response to the one or more nearby electronic devices detecting the one or more low-power prompting signals, the one or more responsive signals when received by the wearable computing device designed to at least notify the wearable computing device that the one or more nearby electronic devices have at least detected the one or more low-power prompting signals broadcasted by the wearable computing device comprises:
broadcasting, by the wearable computing device, the one or more low-power prompting signals by transmitting wirelessly, by the wearable computing device, one or more low-power prompting signals transmitted with signal strength of less than 0.3 milliwatt.

10. The computationally-implemented method of claim 4, wherein said broadcasting, by the wearable computing device, one or more low-power prompting signals to prompt the one or more nearby electronic devices to generate one or more responsive signals in response to the one or more nearby electronic devices detecting the one or more low-power prompting signals, the one or more responsive signals when received by the wearable computing device designed to at least notify the wearable computing device that the one or more nearby electronic devices have at least detected the one or more low-power prompting signals broadcasted by the wearable computing device comprises:
broadcasting, by the wearable computing device, the one or more low-power prompting signals by transmitting wirelessly, by the wearable computing device, one or more low-power prompting signals having one or more frequencies from the 2.4 GHz band.

11. The computationally-implemented method of claim 4, wherein said broadcasting, by the wearable computing device, one or more low-power prompting signals to prompt the one or more nearby electronic devices to generate one or more responsive signals in response to the one or more nearby electronic devices detecting the one or more low-power prompting signals, the one or more responsive signals when received by the wearable computing device designed to at least notify the wearable computing device that the one or more nearby electronic devices have at least detected the one or more low-power prompting signals broadcasted by the wearable computing device comprises:
broadcasting, by the wearable computing device, the one or more low-power prompting signals by transmitting wirelessly, by the wearable computing device, one or more low-power prompting signals having one or more frequencies from the 5 GHz band.

12. The computationally-implemented method of claim 4, wherein said broadcasting, by the wearable computing device, one or more low-power prompting signals to prompt the one or more nearby electronic devices to generate one or more responsive signals in response to the one or more nearby electronic devices detecting the one or more low-power prompting signals, the one or more responsive signals when received by the wearable computing device designed to at least notify the wearable computing device that the one or more nearby electronic devices have at least detected the one or more low-power prompting signals broadcasted by the wearable computing device comprises:
broadcasting, by the wearable computing device, the one or more low-power prompting signals by transmitting wirelessly, by the wearable computing device, one or more low-power prompting signals having one or more frequencies from the 60 GHz band.

13. The computationally-implemented method of claim 4, wherein said broadcasting, by the wearable computing device, one or more low-power prompting signals to prompt the one or more nearby electronic devices to generate one or more responsive signals in response to the one or more nearby electronic devices detecting the one or more low-power prompting signals, the one or more responsive signals when received by the wearable computing device designed to at least notify the wearable computing device that the one or more nearby electronic devices have at least detected the one or more low-power prompting signals broadcasted by the wearable computing device comprises:
broadcasting, by the wearable computing device, the one or more low-power prompting signals by transmitting wirelessly, by the wearable computing device, one or more low-power prompting signals at different levels of low-power signal strengths to facilitate determination of one or more low-power signal strengths needed by the wearable computing device to communicate with the one or more nearby electronic devices.

14. The computationally-implemented method of claim 13, wherein said broadcasting, by the wearable computing device, the one or more low-power prompting signals by transmitting wirelessly, by the wearable computing device, one or more low-power prompting signals at different levels of low-power signal strengths to facilitate determination of one or more low-power signal strengths needed by the wearable computing device to communicate with the one or more nearby electronic devices comprises:
transmitting wirelessly, by the wearable computing device, the one or more low-power prompting signals at different levels of low-power signal strengths to facilitate the determination of the one or more low-power signal strengths needed by the wearable computing device to communicate with the one or more nearby electronic devices including transmitting wirelessly, by the wearable computing device, one or more low-power prompting signals at different levels of low-power signal strengths to facilitate determination of nearness of the one or more nearby electronic devices to the wearable computing device.

15. The computationally-implemented method of claim 13, wherein said broadcasting, by the wearable computing device, the one or more low-power prompting signals by transmitting wirelessly, by the wearable computing device, one or more low-power prompting signals at different levels of low-power signal strengths to facilitate determination of one or more low-power signal strengths needed by the wearable computing device to communicate with the one or more nearby electronic devices comprises:
transmitting wirelessly, by the wearable computing device, the one or more prompting signals at different levels of low-power signal strengths to facilitate the determination of the one or more low-power signal strengths needed by the wearable computing device to communicate with the one or more nearby electronic devices including transmitting wirelessly, by the wearable computing device, one or more low-power prompting signals at different levels of signal strengths below 0.8 milliwatt.

16. The computationally-implemented method of claim 4 wherein said monitoring, by the wearable computing device, for reception of the one or more responsive signals at the wearable computing device in order to detect presence of the one or more nearby electronic devices within the spatial pod comprises:
monitoring, by the wearable computing device, for reception of the one or more responsive signals using an antenna that was used by the wearable computing device to broadcast the one or more low-power prompting signals.

17. The computationally-implemented method of claim 16, wherein said monitoring, by the wearable computing device, for reception of the one or more responsive signals using an antenna that was used by the wearable computing device to broadcast the one or more low-power prompting signals comprises:
monitoring intermittently, by the wearable computing device, for reception of the one or more responsive signals using the antenna that was used by the wearable computing device to broadcast the one or more low-power prompting signals, where the wearable computing device monitoring for the reception of the one or more responsive signals only when the antenna is not broadcasting the one or more low-power prompting signals.

18. The computationally-implemented method of claim 17, wherein said monitoring intermittently, by the wearable computing device, for reception of the one or more responsive signals using the antenna that was used by the wearable computing device to broadcast the one or more low-power prompting signals, where the wearable computing device monitoring for the reception of the one or more responsive signals only when the antenna is not broadcasting the one or more low-power prompting signals comprises:
monitoring intermittently, by the wearable computing device, for reception of the one or more responsive signals using the antenna that was used by the wearable computing device to broadcast the one or more low-power prompting signals at different levels of signal strengths, where the wearable computing device monitoring for the reception of the one or more responsive signals only when the antenna is not broadcasting the one or more low-power prompting signals at the different levels of signal strengths.

19. The computationally-implemented method of claim 3, wherein said detecting presence of one or more electronic devices near a wearable computing device that are within a spatial pod of the wearable computing device, the spatial pod of the wearable computing device being a spatial volume that includes the wearable computing device and being defined by an enveloping boundary, where low-power signals generated by the wearable computing device being discernible over background noise within the enveloping boundary and not discernible over background noise outside the enveloping boundary, the wearable computing device being a computing device designed to be worn by a user comprises:
detecting the presence of the one or more electronic devices near the wearable computing device that are within a spatial pod of the wearable computing device by detecting presence of one or more external linking devices near the wearable computing device that are within the spatial pod of the wearable computing device, the one or more nearby external linking devices being designed to communicate to outside of the enveloping boundary of the spatial pod.

20. The computationally-implemented method of claim 3, wherein said detecting presence of one or more electronic devices near a wearable computing device that are within a spatial pod of the wearable computing device, the spatial pod of the wearable computing device being a spatial volume that includes the wearable computing device and being defined by an enveloping boundary, where low-power signals generated by the wearable computing device being discernible over background noise within the enveloping boundary and not discernible over background noise outside the enveloping boundary, the wearable computing device being a computing device designed to be worn by a user comprises:
detecting the presence of the one or more electronic devices near the wearable computing device that are within a spatial pod of the wearable computing device by detecting presence of one or more other wearable computing devices near the wearable computing device that are within the spatial pod of the wearable computing device.

21. The computationally-implemented method of claim 3, wherein said transmitting, by the wearable computing device, one or more low-power query signals to the one or more nearby electronic devices to query the one or more nearby electronic devices to ascertain which, if any, of the one or more nearby electronic devices provides one or more specific functionalities that are being sought by the wearable computing device comprises:
transmitting, by the wearable computing device, the one or more low-power query signals to the one or more nearby electronic devices by transmitting, by the wearable computing device, one or more low-power query signals that are transmitted having the same signal strength as the signal strength of one or more low-power prompting signals that was broadcasted by the wearable computing device, the one or more low-power prompting signals that was broadcasted by the wearable computing device being for prompting the one or more nearby electronic devices to generate one or more responsive signals in response to the one or more nearby electronic devices detecting the one or more low-power prompting signals, the one or more responsive signals upon being received by the wearable computing device facilitates the wearable computing device to detect presence of the one or more electronic device near the wearable computing device.

22. The computationally-implemented method of claim 3, wherein said transmitting, by the wearable computing device, one or more low-power query signals to the one or more nearby electronic devices to query the one or more nearby electronic devices to ascertain which, if any, of the one or more nearby electronic devices provides one or more specific functionalities that are being sought by the wearable computing device comprises:
transmitting, by the wearable computing device, the one or more low-power query signals to the one or more nearby electronic devices by transmitting, by the wearable computing device, one or more low-power query signals that are transmitted having signal strength or strengths of less than 0.8 milliwatt.

23. The computationally-implemented method of claim 3, wherein said transmitting, by the wearable computing device, one or more low-power query signals to the one or more nearby electronic devices to query the one or more nearby electronic devices to ascertain which, if any, of the one or more nearby electronic devices provides one or more specific functionalities that are being sought by the wearable computing device comprises:
transmitting, by the wearable computing device, one or more low-power query signals to the one or more nearby electronic devices to query the one or more nearby electronic devices to ascertain which, if any, of the one or more nearby electronic devices provides one or more communication functionalities to communicate outside of the spatial pod.

24. The computationally-implemented method of claim 3, wherein said transmitting, by the wearable computing device, one or more low-power query signals to the one or more nearby electronic devices to query the one or more nearby electronic devices to ascertain which, if any, of the one or more nearby electronic devices provides one or more specific functionalities that are being sought by the wearable computing device comprises:
transmitting, by the wearable computing device, one or more low-power query signals to the one or more nearby electronic devices to query the one or more nearby electronic devices to ascertain which, if any, of the one or more nearby electronic devices provides one or more sensor functionalities including one or more global positioning system (GPS) functionalities, one or more audio and/or visual sensor functionalities, and/or one or more movement sensor functionalities.

25. The computationally-implemented method of claim 3, wherein said transmitting, by the wearable computing device, one or more low-power query signals to the one or more nearby electronic devices to query the one or more nearby electronic devices to ascertain which, if any, of the one or more nearby electronic devices provides one or more specific functionalities that are being sought by the wearable computing device comprises:
transmitting, by the wearable computing device, one or more low-power query signals to the one or more nearby electronic devices to query the one or more nearby electronic devices to ascertain which, if any, of the one or more nearby electronic devices provides one or more specific applications.

26. The computationally-implemented method of claim 3, wherein said obtaining, by the wearable computing device, the one or more specific functionalities from the one or more nearby electronic devices based, at least in part, on the one or more confirmation signals received by the wearable computing device comprises:
obtaining, by the wearable computing device, the one or more specific functionalities from the one or more nearby electronic devices by obtaining, by the wearable computing device, one or more communication links to outside of the spatial pod as provided by the one or more nearby electronic devices.

27. The computationally-implemented method of claim 26, wherein said obtaining, by the wearable computing device, the one or more specific functionalities from the one or more nearby electronic devices by obtaining, by the wearable computing device, one or more communication links to outside of the spatial pod as provided by the one or more nearby electronic devices comprises:
obtaining, by the wearable computing device, the one or more communication links to outside of the spatial pod by obtaining, by the wearable computing device, at least access to the Internet via the one or more nearby electronic devices.

28. The computationally-implemented method of claim 3, wherein said obtaining, by the wearable computing device, the one or more specific functionalities from the one or more nearby electronic devices based, at least in part, on the one or more confirmation signals received by the wearable computing device comprises:
obtaining, by the wearable computing device, the one or more specific functionalities from the one or more nearby electronic devices by obtaining, by the wearable computing device, one or more sensor functionalities including one or more GPS functionalities, one or more movement sensor functionalities, and/or one or more visual and/or audio sensor functionalities from the one or more nearby electronic devices.

29. The computationally-implemented method of claim 3, wherein said obtaining, by the wearable computing device, the one or more specific functionalities from the one or more nearby electronic devices based, at least in part, on the one or more confirmation signals received by the wearable computing device comprises:
obtaining, by the wearable computing device, the one or more specific functionalities from the one or more nearby electronic devices by obtaining, by the wearable computing device, access to one or more applications from the one or more nearby electronic devices, the one or more applications being supporting applications for supporting one or more applications being executed by the wearable computing device.

30. The computationally-implemented method of claim 3, wherein said obtaining, by the wearable computing device, the one or more specific functionalities from the one or more nearby electronic devices based, at least in part, on the one or more confirmation signals received by the wearable computing device comprises:
obtaining, by the wearable computing device, the one or more specific functionalities from the one or more nearby electronic devices by selecting the one or more nearby electronic devices for providing the one or more specific functionalities from a plurality of nearby electronic devices that transmitted to the wearable computing device confirmation signals that indicated that each of the plurality of nearby electronic devices possessed the one or more specific functionalities.

31. The computationally-implemented method of claim 30, wherein said obtaining, by the wearable computing device, the one or more specific functionalities from the one or more nearby electronic devices by selecting the one or more nearby electronic devices for providing the one or more specific functionalities from a plurality of nearby electronic devices that transmitted to the wearable computing device confirmation signals that indicated that each of the plurality of nearby electronic devices possessed the one or more specific functionalities comprises:
selecting the one or more nearby electronic devices for providing the one or more specific functionalities from the plurality of nearby electronic devices based, at least in part, on a determination as to which of the plurality of nearby electronic devices are nearest to the wearable computing device.

32. The computationally-implemented method of claim 30, wherein said obtaining, by the wearable computing device, the one or more specific functionalities from the one or more nearby electronic devices by selecting the one or more nearby electronic devices for providing the one or more specific functionalities from a plurality of nearby electronic devices that transmitted to the wearable computing device confirmation signals that indicated that each of the plurality of nearby electronic devices possessed the one or more specific functionalities comprises:
selecting the one or more nearby electronic devices for providing the one or more specific functionalities from the plurality of nearby electronic devices based, at least in part, on a determination as to which of the plurality of nearby electronic devices provide earliest access to the one or more specific functionalities.

33. The computationally-implemented method of claim 30, wherein said obtaining, by the wearable computing device, the one or more specific functionalities from the one or more nearby electronic devices by selecting the one or more nearby electronic devices for providing the one or more specific functionalities from a plurality of nearby electronic devices that transmitted to the wearable computing device confirmation signals that indicated that each of the plurality of nearby electronic devices possessed the one or more specific functionalities comprises:
selecting the one or more nearby electronic devices for providing the one or more specific functionalities from the plurality of nearby electronic devices based, at least in part, on a determination as to which of the plurality of nearby electronic devices are preferred devices as indicated by a user.

34. The computationally-implemented method of claim 3, wherein said obtaining, by the wearable computing device, the one or more specific functionalities from the one or more nearby electronic devices based, at least in part, on the one or more confirmation signals received by the wearable computing device comprises:
obtaining, by the wearable computing device, the one or more specific functionalities from the one or more nearby electronic devices by obtaining, by the wearable computing device, data that is provided as a result of obtaining the one or more specific functionalities.

35. The computationally-implemented method of claim 34, wherein said obtaining, by the wearable computing device, the one or more specific functionalities from the one or more nearby electronic devices by obtaining, by the wearable computing device, data that is provided as a result of obtaining the one or more specific functionalities comprises:
obtaining, by the wearable computing device, the data that is provided as a result of obtaining the one or more specific functionalities by obtaining, by the wearable computing device, data that indicate one or more sensor data including one or more GPS data, one or more movement data, and/or one or more image and/or audio data.

36. The computationally-implemented method of claim 34, wherein said obtaining, by the wearable computing device, the one or more specific functionalities from the one or more nearby electronic devices by obtaining, by the wearable computing device, data that is provided as a result of obtaining the one or more specific functionalities comprises:
obtaining, by the wearable computing device, the data that is provided as a result of obtaining the one or more specific functionalities by obtaining, by the wearable computing device, data that was obtained from outside the spatial pod via one or more communication links provided by the one or more nearby electronic devices.

37. The computationally-implemented method of claim 34, wherein said obtaining, by the wearable computing device, the one or more specific functionalities from the one or more nearby electronic devices by obtaining, by the wearable computing device, data that is provided as a result of obtaining the one or more specific functionalities comprises:
obtaining, by the wearable computing device, the data that is provided as a result of obtaining the one or more specific functionalities by obtaining, by the wearable computing device, hand or arm gesture data that indicates one or more hand and/or arm gestures of a user wearing the wearable computing device.

38. The computationally-implemented method of claim 3, wherein said controlling the wearable computing device based, at least in part, results of obtaining the one or more specific functionalities comprises:
controlling one or more applications being executed by the wearable computing device based, at least in part, on data that was provided as a result of obtaining the one or more specific functionalities.

39. The computationally-implemented method of claim 3, wherein said controlling the wearable computing device based, at least in part, results of obtaining the one or more specific functionalities comprises:
manipulating one or more graphical user interfaces (GUIs) that is presented by the wearable computing device based, at least in part, on data that was provided as a result of obtaining the one or more specific functionalities.

40. The computationally-implemented method of claim 3, wherein said controlling the wearable computing device based, at least in part, results of obtaining the one or more specific functionalities comprises:
controlling the wearable computing device based, at least in part, on data that is provided as a result of obtaining the one or more specific functionalities and that is indicative of hand and/or arm gestures of a user wearing the wearable computing device.
